(19) United States
(12) Patent Application Publication
(10) Pub. No.: US 2025/0310843 A1
(43) Pub. Date: Oct. 2, 2025

(54) TERRESTRIAL TO NON-TERRESTRIAL FAST HANDOVER

(71) Applicant: Dell Products L.P., Round Rock, TX (US)

(72) Inventor: Ali Esswie, Calgary (CA)

(21) Appl. No.: 18/620,418

(22) Filed: Mar. 28, 2024

(51) Int. Cl. H04W 36/08; H04W 36/00; H04W 36/30; H04W 84/06

(52) U.S. Cl. CPC H04W 36/08; H04W 36/0061; H04W 36/302; H04W 84/06

(57) ABSTRACT

A user equipment may be configured to adjust a configured handover offset criterion to facilitate handover from a terrestrial radio network node to a non-terrestrial radio network node. The adjusted handover offset criterion may facilitate the user equipment being handed over to the non-terrestrial node when a difference between reference signal strengths corresponding to the non-terrestrial node and the terrestrial node equals or exceeds the adjusted handover offset, which may be less than the configured unadjusted handover offset criterion. The terrestrial node may communicate, via backhaul communication links, with the non-terrestrial node or a non-terrestrial network element, to obtain non-terrestrial downlink resource and beam information usable by the user equipment to receive connection establishment setup information. The terrestrial node may transmit the non-terrestrial downlink resource and beam information and a timing advance value to the user equipment for use thereby in receiving connection establishment setup information from the non-terrestrial node.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a terrestrial radio network node comprising at least one processor, receiving, from a user equipment, a handover request comprising at least one non-terrestrial handover event indication indicative of at least one non-terrestrial handover event. Responsive to the at least one non-terrestrial handover event indication, the method may comprise facilitating, by the terrestrial radio network node, transmitting, to at least one non-terrestrial network element, a non-terrestrial fast handover request. Responsive to the transmitting of the non-terrestrial fast handover request, the method may comprise facilitating, by the terrestrial radio network node, receiving, from at least one of the at least one non-terrestrial network element, non-terrestrial fast handover request response. Responsive to the receiving of the at least one non-terrestrial fast handover request response, the method may comprise facilitating, by the terrestrial radio network node, transmitting, to the user equipment, a non-terrestrial fast handover command comprising connection establishment information usable by the user equipment to establish a connection with a non-terrestrial network node.

The non-terrestrial fast handover request may comprise at least one of: a non-terrestrial network downlink control resource request for at least one non-terrestrial network downlink control resource usable by the user equipment to facilitate receiving connection setup information, a non-terrestrial downlink beam information request for non-terrestrial downlink beam information usable by the user equipment to facilitate the receiving of the connection setup information, or radio resource control setup request information, associated with the user equipment, usable by the non-terrestrial network node to facilitate establishment of a connection between the non-terrestrial network node and the user equipment.

In an embodiment, the at least one non-terrestrial fast handover request response may comprise at least one of: at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate the receiving of the connection setup information or indicative of beam information corresponding to at least one downlink beam usable by the user equipment to facilitate the receiving of the connection setup information.

In an embodiment, the connection establishment information may comprise at least one of: a non-terrestrial network node identifier corresponding to the non-terrestrial network node, a timing advance value corresponding to the non-terrestrial network node, at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate the receiving of the connection setup information or indicative of beam information corresponding to at least one downlink beam usable by the user equipment to facilitate the receiving of the connection setup information.

In an embodiment, the method may further comprise facilitating, by the terrestrial radio network node, receiving, from at least one of the at least one non-terrestrial network element a first non-terrestrial network handover offset configuration comprising at least one of: at least one non-terrestrial signal strength offset corresponding to at least one non-terrestrial network node, or at least one handover event indication indicative of at least one handover event with respect to which the at least one non-terrestrial signal strength offset is to be applicable.

In an embodiment, the handover request may comprise the at least one non-terrestrial handover event indication being based on a non-terrestrial signal strength corresponding to the non-terrestrial network node being determined to be equal to or greater than at least one adjusted handover event criterion, wherein a configured at least one signal strength offset is adjusted by the at least one non-terrestrial signal strength offset to result in at least one adjusted handover offset, and wherein the at least one adjusted handover event criterion is a result of applying the at least one adjusted handover offset to a terrestrial signal strength corresponding to the terrestrial radio network node.

In an embodiment, the method may further comprise facilitating, by the terrestrial radio network node, transmitting, to the user equipment, a second non-terrestrial network handover offset configuration comprising at least one of: the at least one non-terrestrial signal strength offset, or the at least one handover event indication indicative of the at least one handover event, with respect to which the at least one non-terrestrial signal strength offset is to be applicable.

In an embodiment, the at least one non-terrestrial network element comprises at least one of: a shared core entity, a non-terrestrial gateway, or the non-terrestrial network node.

In an embodiment, the non-terrestrial fast handover request may be delivered via at least one backhaul interface link. The non-terrestrial fast handover request response may be delivered via at least one backhaul interface link. The non-terrestrial fast handover command may be delivered via at least one backhaul interface link. The non-terrestrial fast handover command may be referred to as a fast handover configuration or fast handover configuration information. At least one of the at least one backhaul interface link may be a microwave link.

In another example embodiment, a terrestrial radio network node may comprise at least one processor configured to process executable instructions that, when executed by the at least one processor, facilitate performance of operations that may comprise receiving, from a shared core entity, a non-terrestrial network handover offset configuration comprising non-terrestrial network handover offset configuration information and receiving, from a user equipment, a handover request comprising at least one non-terrestrial handover indication indicative of a non-terrestrial handover event. The handover request may have been transmitted by the user equipment based on at least one radio parameter measurement value, for example a reference signal strength or a coverage level, being determined to satisfy an adjusted handover event criterion corresponding to the non-terrestrial network handover offset configuration information. Responsive to the at least one non-terrestrial handover event indication, the operations may further comprise transmitting, to the shared core entity, a non-terrestrial fast handover request comprising a request for the user equipment to be handed over to a non-terrestrial network node according to the non-terrestrial handover event. Responsive to the transmitting of the non-terrestrial fast handover request, the operations may further comprise receiving, from the shared core entity, at least one non-terrestrial fast handover request response. Responsive to the receiving of the at least one non-terrestrial fast handover request response, the operations may further comprise transmitting, to the user equipment, a non-terrestrial network fast handover command comprising connection establishment information usable by the user equipment to establish a connection with the non-terrestrial network node.

The non-terrestrial network handover offset configuration information may comprise at least one of: at least one non-terrestrial signal strength offset corresponding to at least one non-terrestrial network node, or at least one handover event indication indicative of at least one handover event with respect to which the at least one non-terrestrial signal strength offset is to be applicable.

In an embodiment, the shared core entity may be configured to facilitate exchanging of information between the non-terrestrial network node and the terrestrial radio network node.

The connection establishment information may comprise at least one of: a non-terrestrial network node identifier corresponding to the non-terrestrial network node, a timing advance value corresponding to the non-terrestrial network node, at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate receiving the connection setup information.

The at least one non-terrestrial network downlink control resource usable by the user equipment to facilitate receiving connection setup information may comprise radio resource control connection establishment setup information.

In yet another example, a non-transitory machine-readable medium may comprise executable instructions that, when executed by at least one processor of a terrestrial radio network node, may facilitate performance of operations that may comprise receiving, from a shared core entity, a non-terrestrial handover offset configuration comprising non-terrestrial handover offset configuration information. The operations may further comprise receiving, from a user equipment, a handover request comprising at least one non-terrestrial handover event indication indicative of at least one non-terrestrial handover event, wherein the handover request was transmitted by the user equipment based on at least one radio parameter measurement value, corresponding to a non-terrestrial network node, being determined to satisfy an adjusted handover event criterion corresponding to non-terrestrial network handover offset configuration information. Responsive to the at least one non-terrestrial handover event indication, the operations may further comprise transmitting, to the non-terrestrial network node, a non-terrestrial fast handover request comprising a request for handover of the user equipment to the non-terrestrial network node according to the at least one non-terrestrial handover event. Responsive to the transmitting of the non-terrestrial fast handover request, the operations may further comprise receiving, from the shared core entity, at least one non-terrestrial fast handover request response. Responsive to the receiving of the at least one non-terrestrial fast handover request response, the operations may further comprise transmitting, to the user equipment, a non-terrestrial network fast handover command comprising connection establishment information usable by the user equipment to establish a connection with the non-terrestrial network node.

In an embodiment, the non-terrestrial network node may comprise a satellite. The non-terrestrial network node may comprise a non-terrestrial network node gateway configured to facilitate communication of signals between the satellite and the terrestrial radio network node via at least one microwave interface.

In an embodiment, the receiving of the non-terrestrial network handover offset configuration may comprise receiving the non-terrestrial network handover offset configuration from the non-terrestrial network node gateway. The transmitting of the non-terrestrial fast handover request may comprise transmitting the non-terrestrial fast handover request to the non-terrestrial network node gateway.

In an embodiment, the non-terrestrial handover offset configuration information may comprise at least one non-terrestrial signal strength offset and at least one non-terrestrial handover event indication indicative of the at least one non-terrestrial handover event with respect to which the at least one non-terrestrial signal strength offset is to be applicable.

Another example embodiment, a method may comprise receiving, by a user equipment comprising at least one processor from a terrestrial radio network node, a non-terrestrial network handover offset configuration comprising non-terrestrial network handover information. The method may further comprise determining, by the user equipment, a non-terrestrial signal strength corresponding to a non-terrestrial network node and determining, by the user equipment, a terrestrial signal strength corresponding to the terrestrial radio network node. The method may further comprise adjusting, by the user equipment, at least one configured handover event criterion, corresponding to at least one configured handover event, according to the non-terrestrial network handover information to result in at least one adjusted handover event criterion. The method may further comprise analyzing, by the user equipment, the non-terrestrial signal strength with respect to the terrestrial signal strength to result in a differential signal strength and analyzing, by the user equipment, the differential signal strength with respect to the at least one adjusted handover event criterion to result in an analyzed differential signal strength. The method may further comprise determining, by the user equipment, that the analyzed differential signal strength satisfies the at least one adjusted handover event criterion to result in a determined analyzed differential signal strength. Based on the determined analyzed differential signal strength being determined to satisfy the at least one adjusted handover event criterion, the method may further comprise transmitting, by the user equipment to the terrestrial radio network node, a handover request comprising at least one non-terrestrial handover event indication indicative of at least one non-terrestrial handover event corresponding to the at least one configured non-terrestrial handover event. Responsive to the transmitting of the handover request, the method may further comprise receiving, by the user equipment from the terrestrial radio network node, a non-terrestrial network fast handover command comprising connection establishment information usable by the user equipment to establish a connection with the non-terrestrial network node and establishing, by the user equipment with the non-terrestrial network node, a connection according to the connection establishment information.

The non-terrestrial network handover information may comprise at least one of: at least one non-terrestrial signal strength offset, or the at least one non-terrestrial handover event indication indicative of the at least one non-terrestrial handover event.

In an embodiment, the adjusting the at least one configured handover event criterion may comprise applying the at least one non-terrestrial signal strength offset to the at least one configured handover event criterion to result in the at least one adjusted handover event criterion being lower than the at least one configured handover event criterion corresponding to at least one configured handover event.

The handover request may comprise a non-terrestrial node identifier corresponding to the non-terrestrial network node.

The establishing of the connection may comprise avoiding transmitting of a random-access preamble.

The establishing of the connection may comprise avoiding transmitting of a radio resource control connection establishment request.

In an embodiment, the method may further comprise flushing, by the user equipment, terrestrial network connection information corresponding to the terrestrial radio network node.

In an embodiment, the connection establishment information may comprise at least one of: a non-terrestrial network node identifier corresponding to the non-terrestrial network node, a timing advance value corresponding to the non-terrestrial network node, at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate receiving the connection setup information.

The method may further comprise performing, by the user equipment, blind decoding of the at least one non-terrestrial network downlink control resource. The blind decoding of the at least one non-terrestrial network downlink control resource may be performed via the at least one downlink beam.

In another embodiment a user equipment may comprise at least one processor configured to process executable instructions that, when executed by the at least one processor, may facilitate performance of operations that may comprising receiving, from a terrestrial radio network node, a non-terrestrial network handover offset configuration comprising non-terrestrial network handover information. The operations may comprise determining or receiving a non-terrestrial signal strength corresponding to a non-terrestrial network node and determining or receiving a terrestrial signal strength corresponding to the terrestrial radio network node. The operations may further comprise adjusting a configured handover event criterion according to the non-terrestrial network handover information to result in a non-terrestrial network handover criterion and analyzing the non-terrestrial signal strength with respect to the non-terrestrial network handover criterion to result in an analyzed non-terrestrial signal strength. Based on the analyzed non-terrestrial signal strength being determined to satisfy the non-terrestrial network handover criterion, the operations may further comprise transmitting, to the terrestrial radio network node, a handover request comprising a non-terrestrial handover event indication indicative of a non-terrestrial handover event configured via the non-terrestrial network handover offset configuration. Responsive to the transmitting of the handover request, the operations may further comprise receiving, by the user equipment from the terrestrial radio network node, a non-terrestrial network fast handover command comprising connection establishment information usable by the user equipment to establish a connection with the non-terrestrial network node and establishing, by the user equipment with the non-terrestrial network node, a connection according to the connection establishment information.

In an embodiment, the terrestrial radio network node may be a first terrestrial radio network node. The terrestrial signal strength may be a first terrestrial signal strength. The operations may further comprise analyzing a second terrestrial signal strength corresponding to a second terrestrial radio network node with respect to the configured handover event criterion to result in an analyzed terrestrial signal strength and determining that the analyzed terrestrial signal strength satisfies the configured handover event criterion. However, based on the analyzed non-terrestrial signal strength being determined to satisfy the non-terrestrial network handover criterion, the operations may further comprise avoiding transmission, to the terrestrial radio network node, of a handover request requesting handover to the second terrestrial radio network node.

In an embodiment, the establishing of the connection may further comprise avoiding receiving of grant of uplink resources usable to transmit a connection setup request to the non-terrestrial network node.

In an embodiment, the establishing of the connection may further comprise avoiding transmission of a random-access preamble.

In an embodiment, the establishing of the connection may further comprise avoiding transmission of a radio resource control connection establishment request.

In yet another example embodiment, a non-transitory machine-readable medium may comprise executable instructions that, when executed by at least processor of a user equipment, facilitate performance of operations that may comprise receiving, from a terrestrial radio network node, a non-terrestrial network handover configuration comprising a non-terrestrial network handover offset and a non-terrestrial network handover indication. The operations may further comprise determining a non-terrestrial signal strength corresponding to a non-terrestrial network node to result in a determined non-terrestrial signal strength and determining a terrestrial signal strength corresponding to the terrestrial radio network node to result in a determined terrestrial signal strength. The operations may further comprise adjusting the determined non-terrestrial signal strength based on the non-terrestrial network handover offset to result in an adjusted determined non-terrestrial signal strength and analyzing the adjusted determined non-terrestrial signal strength with respect to a configured handover criterion to result in an analyzed adjusted determined non-terrestrial signal strength. Based on the analyzed adjusted determined non-terrestrial signal strength being determined to satisfy the configured handover criterion, the operations may further comprise transmitting, to the terrestrial radio network node, a handover request comprising the at least one non-terrestrial network handover indication. Responsive to the transmitting of the handover request, the operations may further comprise receiving, by the user equipment from the terrestrial radio network node, a non-terrestrial network fast handover command comprising connection establishment information usable by the user equipment to establish a connection with the non-terrestrial network node. The operations may comprise establishing, by the user equipment with the non-terrestrial network node, a connection according to the connection establishment information.

In an embodiment, the terrestrial radio network node may be a serving terrestrial radio network node serving the user equipment. The configured handover criterion may be configured to be applicable to handover of the user equipment from being served by the serving terrestrial radio network node to being served by a different terrestrial radio network node.

In an embodiment, the adjusting of the determined non-terrestrial signal strength may comprise increasing the determined non-terrestrial signal strength by the non-terrestrial network handover offset. The analyzed adjusted determined non-terrestrial signal strength being determined to satisfy the configured handover criterion may be based on the adjusted determined non-terrestrial signal strength being determined to be higher than the configured handover criterion. The determined non-terrestrial signal strength may be lower than the configured handover criterion.

### BRIEF DESCRIPTION OF THE DRAWINGS

FIG. 1 illustrates wireless communication system environment.

FIG. 2 illustrates an environment with a satellite base station/gateway and satellite that are capable of communication of traffic corresponding to a radio access network.

FIG. 3 illustrates an example environment with a terrestrial radio network node facilitating handoff of a user equipment to a non-terrestrial network node.

FIG. 4A illustrates a user equipment using an example handover event offset configuration to determine to be handed over to a non-terrestrial network node.

FIG. 4B illustrates an example non-terrestrial network handover even offset configuration.

FIG. 5 illustrates an example fast handover request.

FIG. 6 illustrates an example fast handover request response.

FIG. 7 illustrates an example fast handover command.

FIG. 8 illustrates timing diagram of a radio network facilitating fast handover of a user equipment to a non-terrestrial network node.

FIG. 9 illustrates a timing diagram of a user equipment being handed over from being served by a terrestrial network node to being served by a non-terrestrial network node.

FIG. 10 illustrates a flow diagram of an example method to facilitate an idle user equipment being handed over from being served by a terrestrial network node to being served by a non-terrestrial network node.

FIG. 11 illustrates a block diagram of an example method.

FIG. 12 illustrates a block diagram of an example radio network node.

FIG. 13 illustrates a block diagram of an example non-transitory machine-readable medium.

FIG. 14 illustrates a block diagram of an example method.

FIG. 15 illustrates a block diagram of an example user equipment.

FIG. 16 illustrates a block diagram of an example non-transitory machine-readable medium.

FIG. 17 illustrates an example computer environment.

FIG. 18 illustrates a block diagram of an example wireless UE.

FIG. 19 illustrates example acts that may be performed and acts that are avoided by a user equipment during a fast handover from a terrestrial radio network node to a non-terrestrial network node.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence (“AI”) and machine learning (“ML”) models may facilitate performance and operational functionality and improvements in 5G implementation, such as, for example, network automation, optimizing signaling overhead, energy conservation at devices, and traffic-capacity maximization. An artificial intelligence machine learning models (“AI/ML model”) functionality can be implemented and structured in many different forms and with varying vendor-proprietary designs. A 5G radio access network node (“RAN”) of a network to which the user equipment may be attached or with which the user equipment may be registered may manage or control real-time AI/ML model performance at different user equipment devices for various radio functions.

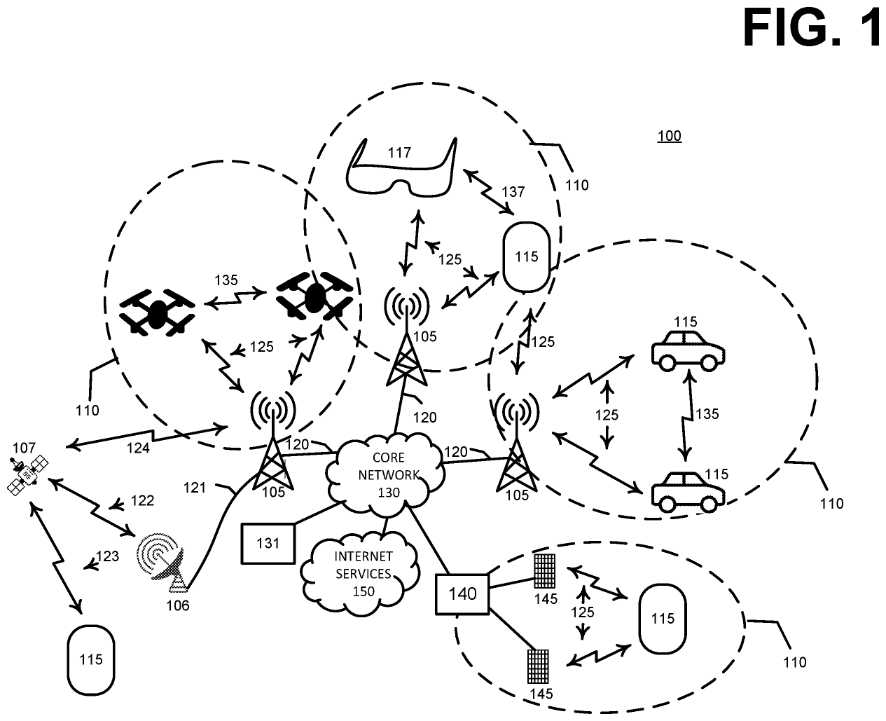

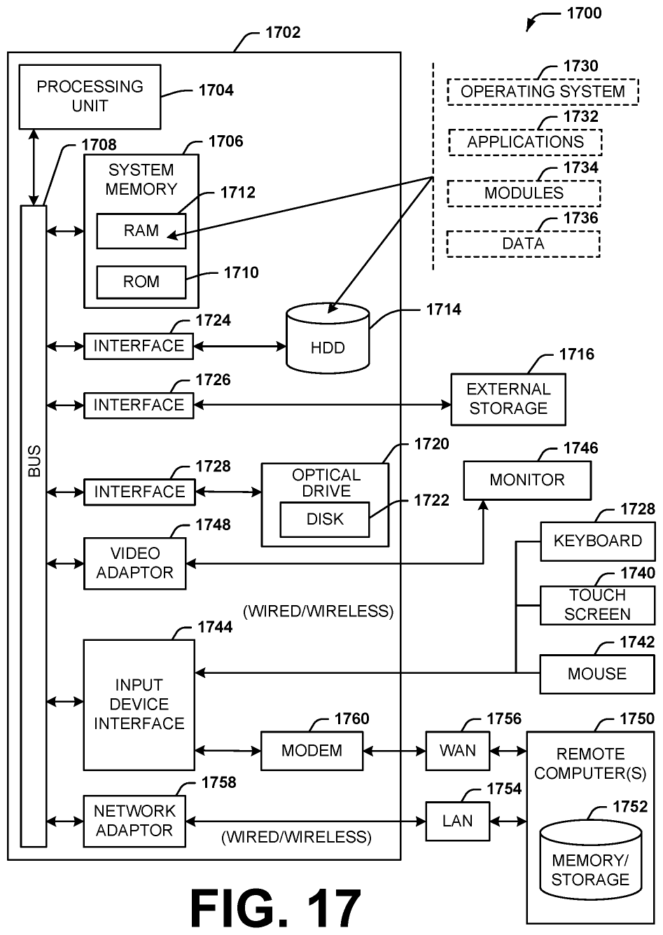

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 17.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies. such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 and 124 to satellite node 107, and links 123 from satellite/node 107 to UE 115, may comprise line-of-sight microwave signal transmission. A UE 115 may be configured with at least one antenna, or at least one processor, to facilitate transmitting or receiving microwave signals to/from satellite node 107. Description of herein, or reference to herein, a radio node or a radio network node may be a description or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial network node may be referred to as a “TN” node. Reference to a satellite node, or a non-terrestrial network node (“NTN node”), may comprise a reference to satellite 107, base station gateway 106, or a combination of satellite 107 and base station/gateway 106.

Core network 130 may comprise, or may be communicatively coupled with, shared core entity 131, which may be referred to as a shared core entity node or a shared core node. Shared core entity 131 may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient.

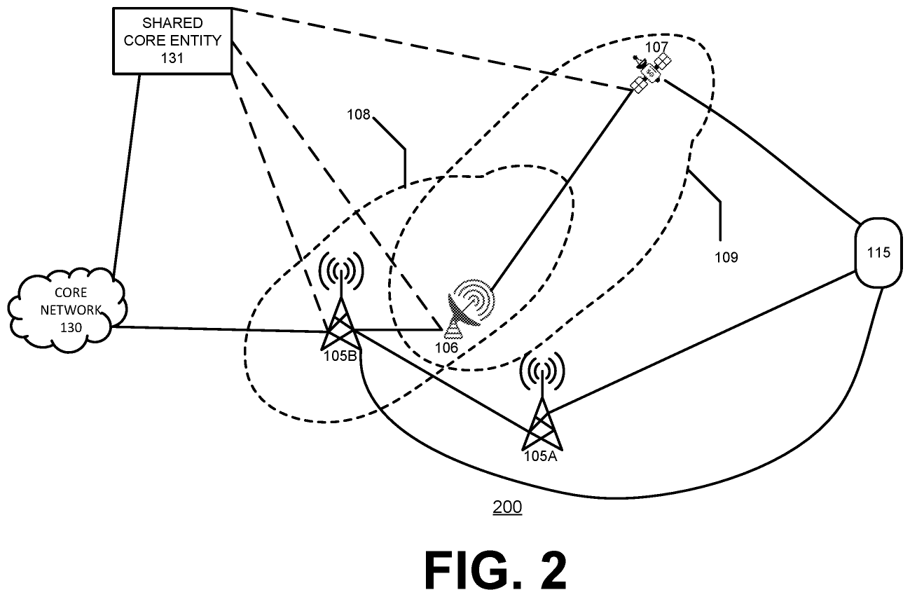

Turning now to FIG. 2, the figure illustrates ground-based RAN node 105, base station 106, and NTN node 107, any one or more of which may be referred to as a radio network node. In reference to some embodiments disclosed herein, reference to a TN node may comprise a reference to node 108, which may comprise one or more of terrestrial RAN node 105 or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105. RAN node 105 may communicate directly with satellite node 107 via communication links 124 or via gateway 106 via links 121 and 122.

Although it may be desirable to implement full or partial gNB functionality (e.g., a RAN node functionality) on board of a satellite serving user equipment on or near the ground, radio network and core network equipment should be configured to interoperate to facilitate integration of ground/terrestrial and space/non-terrestrial systems. To facilitate integration of NTNs with ground cellular networks, fast and energy efficient handover from being served by a terrestrial radio access network node with a limited signal coverage range to being served by a non-terrestrial network node having a wider signal coverage range is desirable. However, using conventional techniques, efficient TN-to-NTN handovers may be impeded by one or more performance-related limitations.

Using conventional techniques, energy consumption at both an NTN-capable user equipment device seeking handover to a non-terrestrial network node and at the non-terrestrial network node may be prohibitively high during handover of the user equipment to the non-terrestrial network node. Conventional techniques require that a user equipment seeking to be handed over from a terrestrial radio access network node serving the user equipment to a target non-terrestrial network node transmit, in the uplink direction, multiple random access and connection establishment information messages and that and that the target non-terrestrial network node transmit multiple downlink resource grants and connection setup configuration messages to the user equipment. Due to the much longer signal propagation distance corresponding to a non-terrestrial network node as compared to a propagation distance between a user equipment and a terrestrial node that is currently serving the user equipment, required transmit power at the user equipment and at the non-terrestrial network node is much higher at the user equipment and at the non-terrestrial network node than when transmitting signals between the user equipment and a terrestrial radio access network node. Furthermore, if a non-terrestrial radio node is facilitating handover of multiple user equipment from terrestrial radio access network nodes to the non-terrestrial radio node, which number of user equipment may be much higher than may be facilitated by a target terrestrial radio access network node in being handed over from another terrestrial radio access network node, using conventional handover procedures to facilitate handover of a user equipment from a TN node to a NTN node imposes a significant energy inefficiency at both NTN-capable user equipment devices and at NTN RAN nodes.

According to embodiments disclosed herein, TN-RAN-node-assisted fast, energy efficient handover from the TN RAN node to an NTN node may minimize the number of needed NTN downlink and uplink control message exchanges between a user equipment and a target NTN node to facilitate successful a TN-to-NTN handover, thus reducing energy consumption at the NTN-capable user equipment device and at the NTN RAN node. Furthermore, embodiments disclosed herein may facilitate a TN RAN node triggering TN-to-NTN handover and sharing connection access information, corresponding to a user equipment seeking to be handed over, with the NTN node. Embodiments disclosed herein may facilitate a TN node receiving, via back haul links from a gateway corresponding to the target NTN/satellite node, NTN downlink connection setup information usable by a user equipment to connection establishment setup information directly from the NTN node without having transmitted random-access preambles to the NTN node. By avoiding transmission by the user equipment to the NTN node of random access preambles, and by triggering handover and sharing information related thereto via backhaul links instead of the use equipment and NTN node sharing handover information via wireless links between the user equipment and the NTN node, time needed for handover of the user equipment from a TN node to the NTN node may be reduced as compared to TN-to-NTN handover according to conventional techniques. Not only may handover from a TN node to a NTN node be faster by using embodiments disclosed herein, but because of fewer UE-NTN uplink transmissions compared to conventional handover techniques and fewer NTN-UE downlink control information transmission, energy consumption for transmission of the uplink transmissions and the downlink control information transmissions is reduced at the user equipment and at the non-terrestrial network node, respectively. The reduction in wireless transmissions between the UE and the NTN node in both the uplink and downlink directions may be facilitated by the offloading of much of the handover signaling from the uplink and downlink radio interfaces between the UE and NTN node to backhaul interface links between the TN RAN node, NTN gateway, or NTN RAN node, which may use compression techniques or energy optimization techniques that are not available for use to facilitate transmissions between the UE and the NTN node. An NTN-capable user equipment device may adaptively execute various actions according to conventional techniques based on whether a TN node has indicated to the UE a conventional TN-to-NTN handover or a fast TN-to-NTN handover.

Unlike with conventional handover event measurement and reporting that is typically triggered by a set of coverage thresholds that are specific to the handover event being satisfied, according to embodiments disclosed herein, multiple coverage thresholds or conditions may be associated with the same handover event, depending on whether a measured signal strength/coverage corresponds to a terrestrial node or to a non-terrestrial node. Therefore, despite triggering the same configured handover event, a user equipment may transmit an NTN measurement report or handover request to a currently-serving terrestrial RAN node earlier than if the UE measures a signal strength corresponding to a terrestrial node to which the UE request handover according to the configured handover event.

Unlike with conventional handover techniques that require that a currently serving source RAN node only transfers device context information to a target RAN node while leaving most, if not all, of conveying of actual access configuration information to the user equipment to be handed over and to target/destination RAN node to which the UE is to be handed over, which may be referred to as a slow handover, according to embodiments disclosed herein, a source RAN node may obtain access information corresponding to a target RAN node to facilitate a fast handover. Embodiments disclosed herein may comprise novel backhaul and radio signaling to facilitate delivery of fast handover messages and fast handover commands.

Conventional handover techniques require static handover stack execution, wherein user equipment, to be handed over to a target node, first transmits to the target node an uplink preamble to the target node, second receives an uplink resource grant from the target node, third transmits a connection setup request to the target node, fourth receives, from the target node, a downlink grant of downlink resources usable to receive connection establishment setup information from the target node, and finally receives connection configuration/connection establishment setup information. Unlike with conventional techniques, according to embodiments disclosed herein, one or more conventional handover stack execution actions may be avoided, or adaptively altered.

### Terrestrial to Non-Terrestrial Fast Handover.

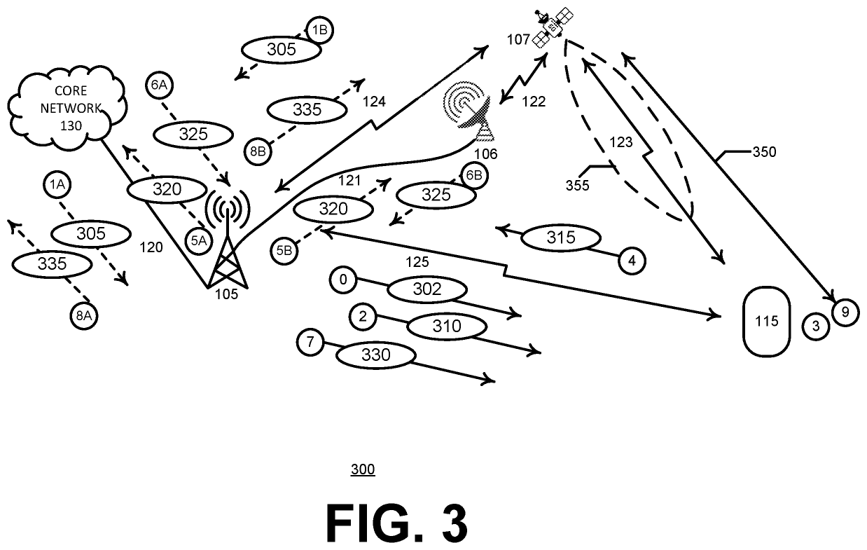

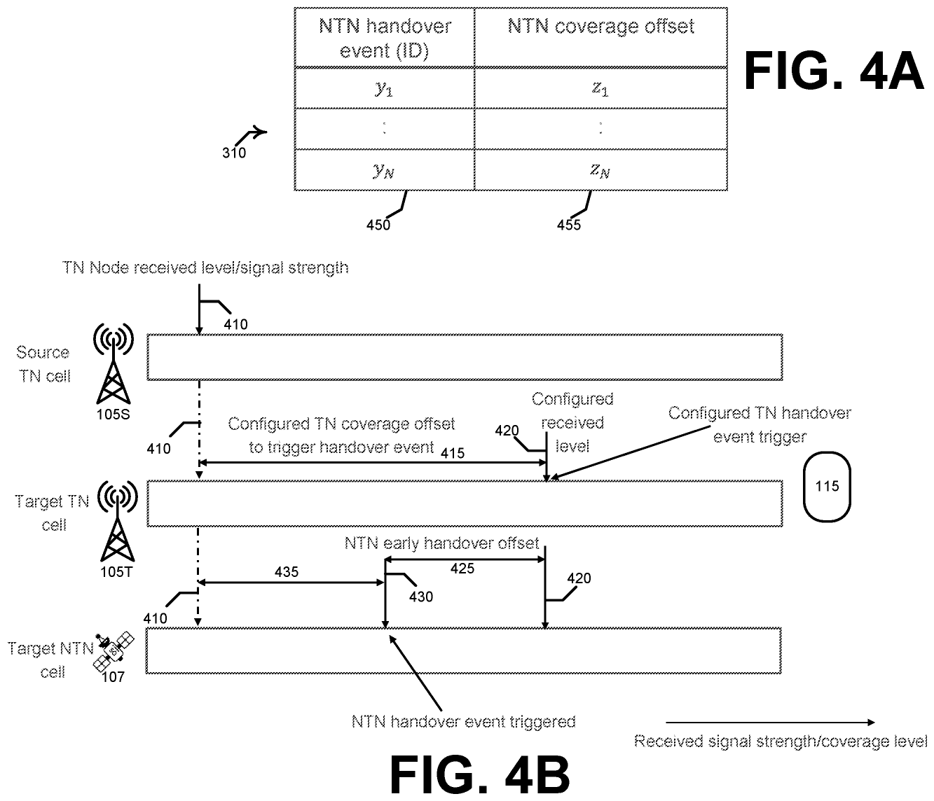

Turning now to FIG. 3, at act 0, NTN-capable user equipment 115 may receive from terrestrial network node 105 handover event configuration 302 according to conventional techniques. Configuration 302 may comprise configured handover event criterion, for example a signal strength offset (e.g., signal strength criterion 420 shown in FIG. 4B) to be applied by user equipment 115 to a signal strength corresponding to a terrestrial radio access network node, such as RAN node 105, currently serving the user equipment (e.g., UE 115 may apply offset 420 to detected signal strength 410 corresponding to serving RAN node 105S in FIG. 4B).

According to conventional techniques, by applying configured offset 420 to received signal strength 410, as shown in FIG. 4B, user equipment 115 may determine to trigger transmitting of a handover request to source/serving terrestrial radio access network node 115S to request handover to target terrestrial radio access network node 115T. Determining to trigger the transmitting of a handover request may be referred to as a handover event. Upon the user equipment detecting that a signal strength 420 corresponding to target terrestrial radio access network node 115T equals or exceeds the currently detected signal strength 410 corresponding to terrestrial radio access network node 115S plus the configured handover event offset 420, user equipment 115 may trigger reporting, to currently serving radio access network node 1155, a handover event indication indicative of at least one configured handover event.

Continuing with description of FIG. 3, according to embodiments disclosed herein, terrestrial network RAN node 105 may receive NTN-specific handover offset configuration 305 from core network 130, from TN-NTN shared core entity 131 (e.g., at act 1A), and/or NTN gateway (e.g., at act 1B) via backhaul interface links 120 or 121. Configuration 305 may comprise an NTN-specific coverage difference offset, for example offset 425 shown in FIG. 4B. Offset 425 may be usable by a user equipment to determine to trigger the reporting of a handover event. Information contained in configuration 305 may facilitate TN RAN node 105 in configuring NTN-capable user equipment 115 to trigger reporting a handover event measurement to an NTN node earlier than a configured handover event criterion/criteria that may be configured, according to conventional techniques, for use in triggering reporting of a handover event measurement corresponding to a request to be handed over from one terrestrial network node to another terrestrial network node. Thus, despite user equipment 115 being configured, via configuration 302, to trigger reporting of a handover event with respect to signal strength measurements corresponding to NTN node 107 and TN RAN node 105, the user equipment may trigger reporting of the handover event when a signal strength corresponding to the non-terrestrial network node is greater than a configured signal strength differential criterion minus an offset value configured via configuration 305 (e.g., reporting may be triggered by a signal strength 430 corresponding to node 107 being equal to or greater than configured value 420 minus offset 425). By reporting a configured handover event, and a corresponding handover request, based on a signal strength difference between a signal strength corresponding to node 107 and RAN node 105 being less than a signal strength differential criterion configured via configuration 302, user equipment 115 may transmit a handover request to serving RAN node 105 sooner than if the user equipment waited to transmit a handover request until a signal strength corresponding to node 107 exceeds a signal strength corresponding to node 105 by an amount equal to or greater than a handover event criterion (e.g., offset 415) configured via configuration 302.

Triggering the transmitting, by UE 115 to RAN node 105, of a handover request requesting handover from terrestrial node 105 to non-terrestrial node 107 earlier than would result from applying a configured handover criterion (e.g., earlier in the sense that a signal strength corresponding to the non-terrestrial node exceeds a signal strength corresponding to the terrestrial node by less than a configured handover event criterion amount that may be configured to be applicable to terrestrial-to-terrestrial handover), may result in time for the terrestrial node and the non-terrestrial node to transmit, receive, and process various signals that facilitate handover that may be less than if the UE waited until signal strength 420 corresponding to a target node equals or exceeds signal strength 420. If satellite node 107 comprises RAN node functionality (e.g., a gNodeB stack), time for signals to traverse the space between RAN node 105 and the satellite node may be longer than time for signals to traverse between neighboring RAN nodes. Thus, with respect to handover according to a conventional configured handover trigger criterion, which may be configured for use for terrestrial-to-terrestrial handover, additional time that may result from earlier handover event reporting/handover request transmission may facilitate transmission of signals over a longer distance between a target satellite node and a source terrestrial node being performed before the user equipment that is to be handed over moves beyond a coverage of the currently serving source terrestrial radio network node. Accordingly, early triggering of handover measurement reporting by user equipment 115 may increase the likelihood that TN RAN node 105 has sufficient time for TN-to-NTN or NTN-to-TN signal exchanges via backhaul links between TN RAN node 105 and NTN node 107 to occur and to be processed before signal strength coverage at the user equipment with respect to the currently serving RAN node 105 fails to facilitate communication/connection between UE 115 and RAN node 105.

At act 2, TN RAN node 105 may transmit NTN-specific handover event offset configuration 310, which may be referred to as a non-terrestrial network handover offset configuration or a handover offset configuration comprising information extracted from configuration 305 (e.g., offset 425 shown in FIG. 4), toward NTN capable device 115 via radio interface link(s) 125. At act 3, NTN-capable UE 115 may measure received coverage levels (e.g., signal strengths) corresponding to signals received from NTN node 107 and TN node 105. At act 4, based on signal strength values measured at act 3, NTN-capable UE 115 may transmit to TN RAN node 105 NTN handover request 315 via one or more uplink radio interface link(s) 125. UE 115 may determine to transmit request 315 based on a difference between a signal strength 430 measured with respect to NTN node 107 and a signal strength 410 measured with respect to the RAN node 105 being determined to be equal to or greater than a configured handover event criterion 415 that has been reduced by a non-terrestrial signal strength offset 425 corresponding to non-terrestrial network node 107 to result in an adjusted handover criterion 435. In an embodiment, instead of reducing a configured handover even criterion by the non-terrestrial signal strength offset corresponding to non-terrestrial network node 107, UE 115 may increase a signal strength value corresponding to the signal strength measured with respect to NTN node 107 by the non-terrestrial signal strength offset and analyze the increased signal strength with respect to an unadjusted configured handover event criterion.

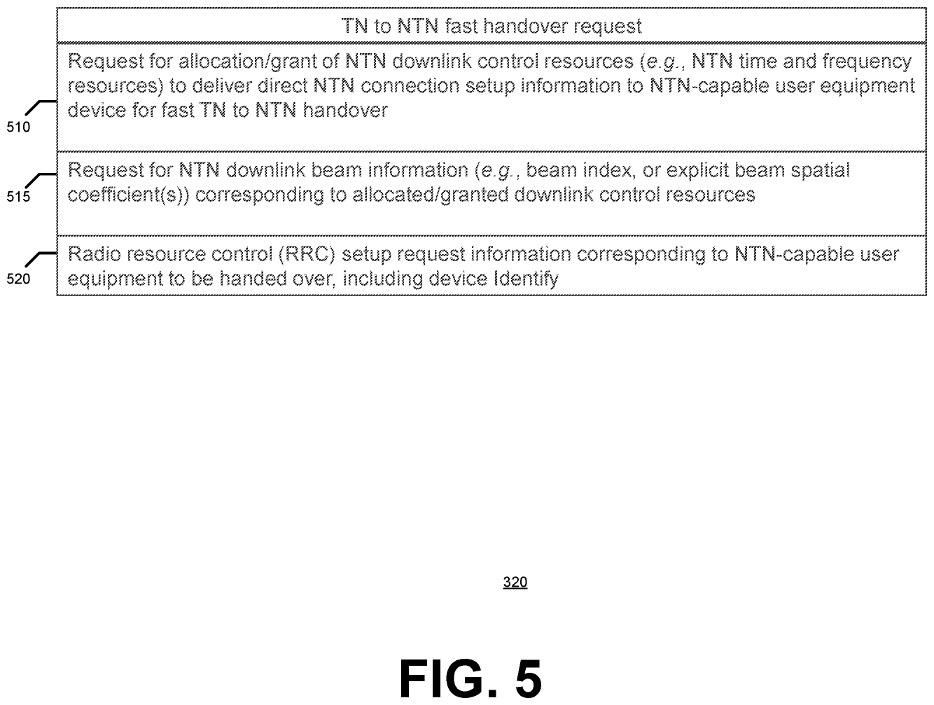

Responsive to, and based on, handover request 315, TN RAN node 105 may generate and transmit, at act 5 to NTN node 107, NTN fast handover request 320. As shown in FIG. 5, request 320 may comprise in field 510 a request, or a request indication indicative of a request, for allocation of NTN downlink control resources usable by UE 115 to receive, from NTN node 107 via NTN spectrum corresponding to NTN node 107, NTN connection setup information to facilitate fast handover from TN node 105 to NTN node 107. The term ‘fast’ may refer to a reduction in time needed to set up a connection between UE 115 and NTN node 107. Compared to UE transmitting a handover request directly to NTN node 107 via link(s) 123, which may take 0.500 milliseconds to be received by NTN node 107, transmission, by UE 115, of request 315 to RAN node 105 via link(s) 125, can typically be received from UE 115 by TN node 105 and delivered thereby to NTN node 107 via link(s) 121 and 122 or via link(s) 124 in substantially less time than 0.500 milliseconds.

Request 320 may comprise in field 515 a request, or a request indication indicative of a request, for NTN downlink beam information (e.g., a beam index, or explicit beam spatial coefficients), corresponding to NTN downlink control resources, that may be requested in field 510, to be usable by a user equipment to receive fast handover connection setup information. Request 320 may comprise, in field 520, radio resource control (“RRC”) setup request information including an identifier corresponding to a user equipment requesting handover from a terrestrial node to a non-terrestrial node. Resource allocation request 510 and beam information request 515 may facilitate the TN RAN node that is handing over a user equipment to proactively obtain RRC access information corresponding to a non-terrestrial node that the user equipment is to be handed over to facilitate fast and energy-efficient handover of the user equipment.

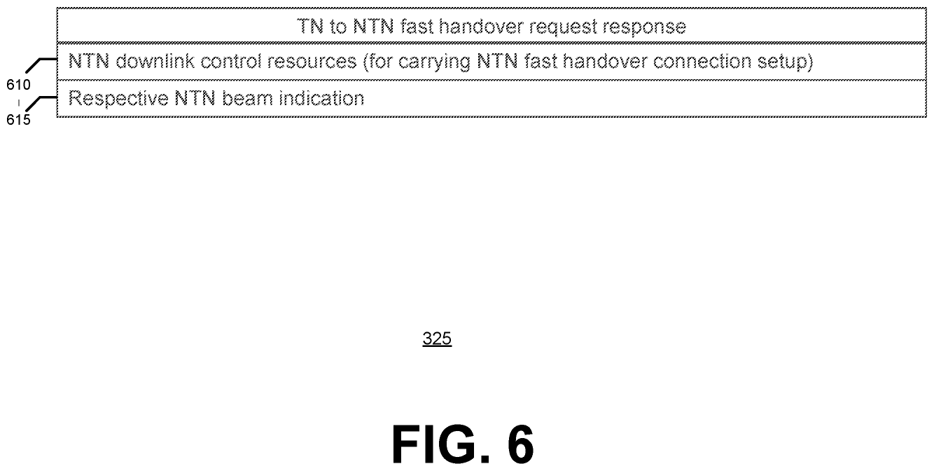

Responsive to request 320, TN RAN node 105 may receive non-terrestrial fast handover request response downlink control resource grant information 325, shown in FIG. 3 and FIG. 6. Request response 325 may comprise in field 610 NTN timing resource information and frequency resource information and in field 615 downlink NTN beam information (e.g., an implicit indication or explicit actual information) corresponding to a beam via which fast handover connection setup information may be transmitted by the NTN RAN node to the user equipment requesting a handover to the NTN node. Accordingly, NTN-capable user equipment device 115, shown in FIG. 3, can directly monitor NTN control resources corresponding to satellite 107, configured via response 325, and receive RRC connection setup information without the need to transmit uplink preambles or RRC setup requests to the satellite, thus achieving faster and more energy efficient TN-to-NTN handover than if the user equipment transmits preambles and RRC setup requests directly to the satellite. The speed increase may be in part due to transmission of signals via link(s) 125 and backhaul link 121, 122, or 124 occurring faster than transmission, especially in the uplink direction, between UE 115 and satellite 107 via link(s) 123.

TN RAN node 105 may transmit request 320 to core network 130 and/or toward TN-NTN shared core entity at act 5A, and/or, at act 5B, toward NTN gateway 106 via backhaul interface link(s) 121. Responsive to transmitting request 320, TN RAN node 105 may receive, from NTN gateway 106 at act 6B and/or from shared TN-NTN core entity 130 at act 6A, via backhaul interface links, NTN downlink control resource indication 325, which may be referred to as an NTN fast-handover request response. Indication 325 may comprise an indication of at least one NTN beam (e.g., beam 355 shown in FIG. 3), corresponding to NTN node 107, to which UE 115 may use to receive setup information if handed over to the NTN node.

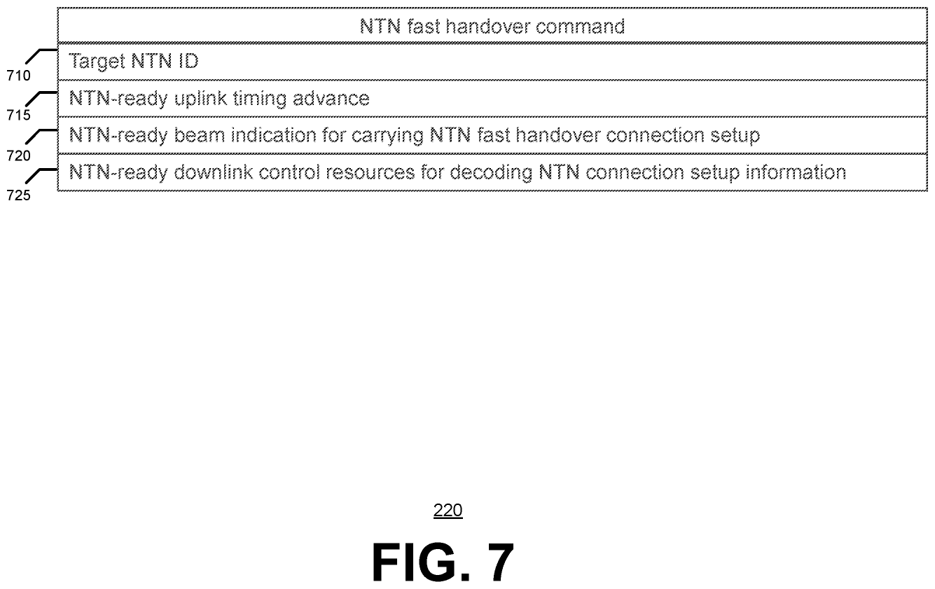

At act 7, TN RAN node 105 may transmit, toward NTN-capable user equipment 115 via TN downlink radio interface link(s) 125, TN-to-NTN fast handover configuration 330, which may be referred to as a non-terrestrial fast handover command. As shown in FIG. 7, configuration/command 330 may comprise in field 710 a target NTN node identifier (e.g., an identifier corresponding to NTN node 107). In field 715, configuration/command 330 may comprise an uplink timing advance corresponding to user equipment 115 determined with respect to NTN node 107. In field 720, configuration/command 330 may comprise beam information, corresponding to downlink beam 355, usable to deliver NTN fast handover connection setup information from NTN node 107 to user equipment 115. In field 725, configuration/command 330 may comprise downlink control resource information usable by the user equipment to decode NTN connection setup information transmitted by NTN node 107. At act 8A shown in FIG. 3, TN RAN node 105 may transmit NTN handover path switch request 335 to core network 130, to TN-NTN shared core entity 131, or, at act 8B, to NTN gateway 106, via backhaul interface link(s) 120 and/or 121.

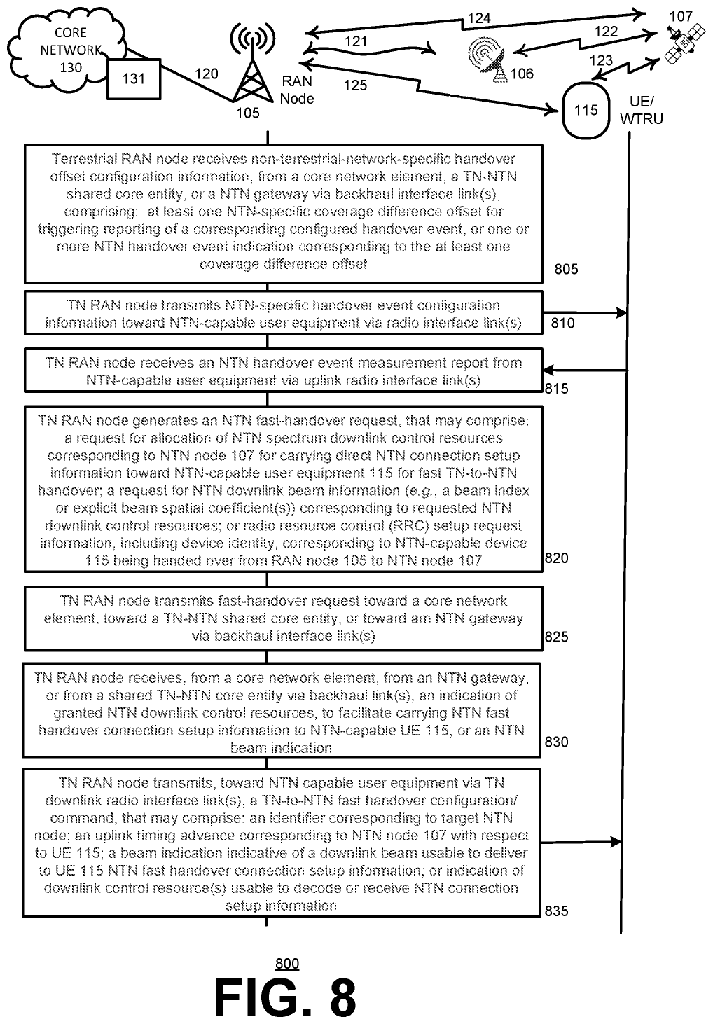

Turning now to FIG. 8, the figure illustrates a timing diagram of an example method 800. At act 805, terrestrial RAN node 105 may receive a non-terrestrial-network-specific handover offset configuration from core network 130, TN-NTN shared core entity 131, or NTN gateway 106 via backhaul interface link(s). The configuration received at act 805 (e.g., configuration 305 described in reference to FIG. 3) may comprise an NTN-specific coverage difference offset (e.g., offset 425, which may be indicated in field 405, shown in FIG. 4), usable by UE 115 to facilitate triggering the reporting of a corresponding handover event indicated in field 450. The configuration received at act 805 may comprise at least one NTN handover event associated with at least one offset to which the at least one offset is to be applicable by UE 115. At act 810, TN RAN node 105 may transmit NTN-specific handover event offset configuration (e.g., configuration 310 shown in FIG. 4) toward NTN-capable device 115 via radio interface link(s) 125.

At act 815, TN RAN node may receive an NTN handover event measurement report (e.g., request 315 shown in FIG. 3), which may be referred to as a handover request, from NTN-capable UE/WTRU 115 via uplink radio interface link(s) 125. At act 820, responsive to receiving the handover request at act 815, TN RAN node 105 may generate an NTN fast-handover request (e.g., request 320 shown in FIGS. 3 and 5). The fast-handover request generated at act 820 may comprise a request for an allocation/grant of NTN control channel downlink resources, corresponding to NTN spectrum associated with NTN node 107 usable to deliver NTN connection setup information directly from NTN node 107 to NTN-capable user equipment 115 to facilitate fast TN-to-NTN handover. The fast handover request generated at act 820 may comprise a request for NTN downlink beam information (e.g., a beam index indicative of a beam or explicit beam spatial coefficients that may partially define a beam) corresponding to requested control channel downlink resources that may be granted response to the fast handover request. Granting of requested downlink control channel resources and beam information may facilitate UE 115 receiving connection setup information without the UE transmitting a request for the resources and beam information via link(s) 123, which would likely be a slower transmission than transmission of the fast handover request by TN node 105. The request generated at act 820 may comprise NTN-capable device radio resource control setup request information, corresponding to NTN-capable UE/WTRU 115, including a device identifier corresponding to UE 115. At act 825, TN RAN node 105 may transmit, toward NTN node 107 via backhaul interface links, the fast handover request generated at act 820. In an embodiment, the fast handover request generated at act 820 may be transmitted at act 825 to core network 130. In an embodiment, the fast handover request generated at act 820 may be transmitted at act 825 to TN-NTN shared core entity 131.

Responsive to transmitting the fast handover request, at act 830 TN RAN node 105 may receive, from NTN gateway 106, from shared TN-NTN core entity 131, or from NTN node 107, via backhaul interface link(s), a fast handover request response (e.g., response 325) comprising NTN downlink control resources for delivering NTN fast handover connection setup information and corresponding NTN beam information. At act 835, TN RAN node 105 may transmit, towards the NTN capable device 105 via TN downlink radio interface link(s) 125, TN-to-NTN fast handover configuration/command (e.g., command 330). The configuration/command transmitted at act 835 may comprise an NTN identifier corresponding to NTN node 107. The configuration/command transmitted at act 835 may comprise an uplink timing advance value, which may be dynamically determined, corresponding to UE with respect to NTN node 107. The configuration/command transmitted at act 835 may comprise beam information indicative of a beam usable to deliver NTN fast handover connection setup information from NTN node 10-7 to UE 115. The configuration/command transmitted at act 835 may comprise an indication of granted downlink control resources usable by UE 115 to decode or to receive NTN connection setup information, which the UE may use to establish a connection with NTN node 107. TN RAN node 105 may compile and transmit, via backhaul interface link(s) an NTN handover path switch request towards core network 130, toward TN-NTN shared core entity 131, or toward NTN gateway 106.

### Device Energy Efficient Non-Terrestrial Access.

As shown in FIG. 3, NTN-capable WTRU/device 115 may receive non-terrestrial network handover event offset configuration 310. As shown in FIG. 4A, configuration 310 may comprise at least one non-terrestrial signal strength offset 455 and at least one handover event indication 450 indicative of at least one handover event, with respect to which the at least one non-terrestrial signal strength offset is to be applicable by user equipment 115 in determining whether to request a handover from a terrestrial network node to a non-terrestrial network node. UE 115 may receive configuration 310 from serving TN RAN node 105 via downlink link(s) 125. An NTN-specific coverage difference offset 455 may be usable by UE 115 to determine to trigger reporting to TN RAN node 105 of a corresponding handover event, which may be indicated in a respective at least one NTN handover event field 450 and which may result in a handover from TN node 115 to NTN node 107.

At act 3, NTN-capable UE/WTRU 115 may detect and determine received coverage levels (e.g., signal strengths corresponding to received signals) corresponding to one or more active TN RAN nodes or NTN RAN nodes, based on downlink reference signals (e.g., full or partial synchronization signal blocks signals). As shown in FIG. 4B, on condition of UE 115 being configured to monitor and evaluate a configured handover event, UE 115 may ascertain a default coverage threshold/criterion 415, corresponding to the configured handover event for determining handover from a terrestrial node to another terrestrial node and adjust the ascertained configured criterion 415 by NTN-specific coverage offset 425 to result in an adjusted NTN handover criterion 435. Accordingly, instead of a waiting to determine a difference between a coverage level 410 corresponding to current serving RAN node 105 and a coverage level 420 corresponding to NTN node 107 that equals or exceeds configured criterion offset 415 before transmitting handover request 315 at act 4, UE 115 may transmit handover request 315 to TN RAN node as soon as a coverage level corresponding to NTN node 107 is determined to exceed coverage level 410 by adjusted criterion 435. Accordingly, user equipment 115 may transmit to TN RAN node 105 handover request 315 earlier than if the user equipment waits until determining that a difference between detected coverage levels 420 and 410 exceeds configured criterion 415.

At act 4, on condition of adjusted criterion 435 being determined to be satisfied by signal coverage level 430, corresponding to NTN node 107, which is lower, or weaker, than coverage level 420, UE 115 may compile and early-transmit handover request 315 to TN RAN node 105 (e.g., the UE transmits request 315 earlier than if the UE waits until coverage level 420 corresponding to NTN node 107 satisfies criterion 415). Request 315 may comprise a unique identifier corresponding to UE 115.

At act 7, shown in FIG. 3, UE 115 may receive from serving TN RAN node 105, via TN downlink radio interface link(s) 125, TN-to-NTN fast handover configuration/command 330 that may comprise an identifier corresponding to target NTN RAN node 105 and/or a determined uplink timing advance value corresponding to UE 115. Configuration/command 330 may comprise beam information indicative of a downlink beam (e.g., beam 355) usable by UE 115 to receive fast handover connection setup and/or downlink control resource information indicative of downlink resources usable by UE 115 to decode or receive NTN connection setup information transmitted by NTN node 107 to UE 115.

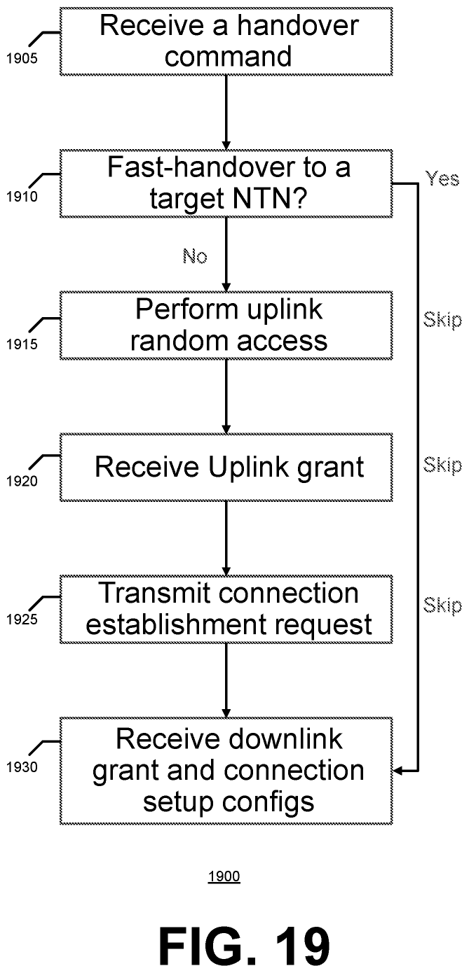

At act 9, UE/WTRU 115 may release and flush TN connection information corresponding to a current connection with respect to TN RAN node 105. After receiving an NTN fast-handover command 330 from serving TN RAN node 105 (indicated by block 1905 shown in FIG. 19) that indicates that UE 115 is to be handed over to NTN node 107 (indicated by block 1910 in FIG. 19), UE/WTRU may override conventional handover protocol stack behavior and skip random access (preamble) transmission 1915 and resource radio control (RRC) connection establishment request transmissions 1920 and 1925 shown in FIG. 19. UE/WTRU 115 may monitor and blindly decode downlink control resources, indicated by command 330, to receive, according to conventional techniques, NTN RRC connection setup configurations, from the target NTN RAN node 107 via an NTN downlink beam indicated in command 330 (e.g., as indicated by block 1930 shown in FIG. 19). Based on RRC connection establishment information received according to resource and beam information indicated in command 330, UE 115 may establish a connection with NTN node 107 without the UE having transmitted a random access preamble to the NTN node, without the UE having received, from the NTN node, an uplink resource grant of resources for transmitting an establishment request to the NTN node, and without the UE having transmitted an uplink connection establishment request to NTN node.

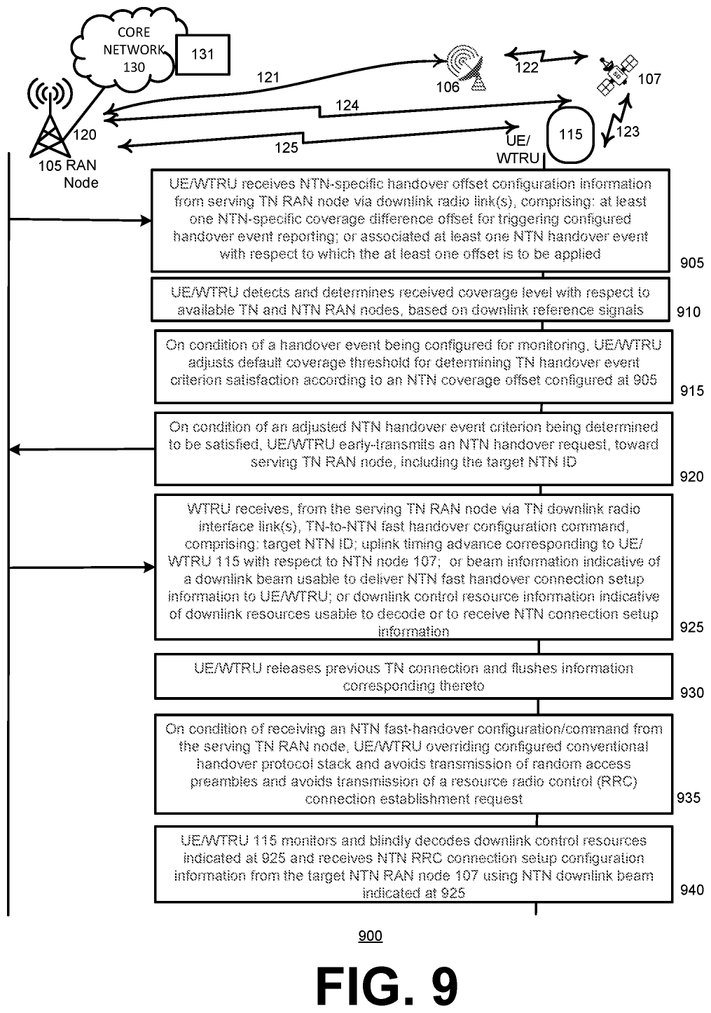

Turning now to FIG. 9, the figure illustrates a timing diagram of a method 900. At act 905, UE/WTRU 115 may receive, from RAN node 105 via radio interface link(s), a non-terrestrial-network-specific handover offset configuration. The configuration received at act 905 may comprise at least one NTN-specific coverage difference/offset, usable by UE 115 to trigger reporting of at least one configured handover event, or at least one NTN handover event indication indicative of at least one configured handover event, to which at least one of the at least one NTN offset is to be applied. At act 910, UE/WTRU 115 may determine received coverage levels corresponding to TN node 105 and NTN RAN node 107, based on downlink reference signals, for example full or partial synchronization signal blocks signals. At act 915, with respect to at least one configured handover event, UE/WTRU 115 may apply an offset (e.g., offset 425 shown in FIG. 4B), corresponding to the at least on handover event associated with the at least one offset in the configuration received at act 905, to a configured offset (e.g., offset 415 shown in FIG. 4B) that may be configured for use with respect to a TN-to-TN handover or TN-to-NTN handover according to conventional techniques. UE/WTRU 115 may determine whether a measured signal strength corresponding to NTN node 107 equals or exceeds an adjusted NTN handover criterion (e.g., the UE may determine whether a signal strength corresponding to a reference signal broadcast by NTN node 107 equals or exceeds adjusted threshold/criterion 435 shown in FIG. 4B).

On condition of determining at act 915 that a reference signal strength corresponding to NTN node 107 equals or exceeds an adjusted NTN handover criterion, at act 920 UE/WTRU 115 may early-transmit an NTN handover request (e.g., request 315 shown in FIG. 3), toward serving TN RAN node 105. The NTN handover request may comprise an identifier corresponding to target NTN node 107. At act 925, UE/WTRU 115 may receive, from serving TN RAN node 105 via TN downlink radio interface link(s) 125, a TN-to-NTN fast handover configuration/command (e.g., command 330 shown in FIGS. 3 and 7). The configuration/command received at act 925 may comprise: an identifier corresponding to target NTN node 107; a timing advance value corresponding to UE/WTRU 115 determined with respect to NTN node 107; beam information indication indicative of a beam to be used by the UE/WTRU for receiving NTN fast handover connection setup information; or downlink control channel resources usable by UE/WTRU to decode or to receive NTN connection setup information to facilitate establishing a connection between UE/WTRU and NTN node 107.

At act 930, UE/WTRU 115 may release and flush TN connection information corresponding to a connection between UE and TN node 105. At act 935, based on having received command 330 at act 925, UE/WTRU 115 may override conventional handover protocol stack instructions and skip/avoid transmission of random-access preamble(s) or transmission of resource radio control connection establishment request messages. At act 940, UE/WTRU 115 may monitor and blindly decode downlink control channel resources, indicated in command 330 received at act 925, and receive, from target NTN RAN node 107, NTN RRC connection setup configuration information using the configured NTN downlink beam indicated in command 330 received at act 925.

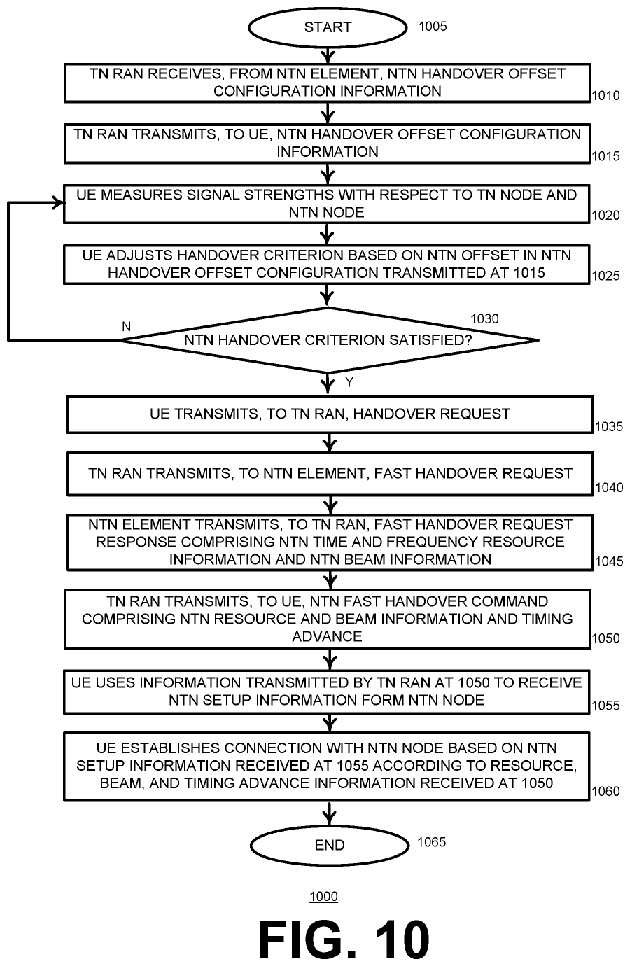

Turning now to FIG. 10, the figure illustrates a flow diagram of an example method 1000. Method 1000 begins at act 1005. At act 1010, a terrestrial radio access network node may receive, from a non-terrestrial network element, non-terrestrial network handover offset configuration information (e.g., information contained in configuration 305 described in reference to FIG. 3). A non-terrestrial network element may comprise at least one of: a core network element of core network 130 described in reference to FIG. 1, a shared terrestrial-non terrestrial core element, such as element 131, a non-terrestrial network gateway such as gateway 106, or a non-terrestrial network node, such as satellite node 107. At act 1015, the terrestrial radio access network node may transmit, to a user equipment, non-terrestrial network handover offset configuration information, which may comprise some of, or all of, the non-terrestrial network handover offset configuration information received by the terrestrial radio access network node at act 1010. At act 1020, the user equipment may measure signal strengths corresponding to reference signals transmitted, or broadcast, by the terrestrial radio access network node and a non-terrestrial network node.

At act 1025, the user equipment may adjust a handover event criterion, corresponding to a handover event that may be usable to determine whether to hand over from a terrestrial radio access network node to another node, by a non-terrestrial network offset amount, or value, that may be indicated in the handover offset configuration transmitted at act 1015. The handover event criterion that is adjusted by the non-terrestrial network offset amount may be a handover event criterion configured in the user equipment by the terrestrial radio access network node before the transmitting, at act 1015, of the non-terrestrial network handover offset configuration information. The handover event criterion that is adjusted by the non-terrestrial network offset amount may be an offset that is configured to be applied to a signal strength corresponding to the terrestrial radio access network node to facilitate the user equipment requesting hand over from a terrestrial radio access network node serving the user equipment to another node, which may be a terrestrial radio access network node or a non-terrestrial network node, when the user equipment determines that a signal strength corresponding to the other node exceeds the signal strength corresponding to the serving terrestrial radio access network node by an amount equal to or greater than the already-configured handover event criterion.

Accordingly, in an embodiment, adjusting, by the user equipment, of the already-configured handover criterion may comprise the user equipment reducing the already-configured handover criterion by the non-terrestrial network offset amount, transmitted by the terrestrial radio access network node at act 1015, to result in a reduced offset amount such that the user equipment requests handover when a signal strength corresponding to a target node (e.g., a non-terrestrial network node), other than the terrestrial radio access network node currently serving the user equipment, is determined to equal or exceed the reduced offset amount. In another embodiment, adjusting, by the user equipment, of the already configured handover criterion may comprise increasing a signal strength determined by the user equipment with respect to a target non-terrestrial network node by the non-terrestrial network offset amount configured at act 1015 instead of reducing the already-configured handover criterion. Thus, the user equipment may determine to request handover from a terrestrial radio access network node currently serving the user equipment to a non-terrestrial network node upon determining that a signal strength corresponding to the non-terrestrial network node equals or exceeds a signal strength corresponding to the terrestrial radio access network node that is currently serving the user equipment by an amount that is less than a handover criterion that has been configured in the user equipment for use in determining whether to request handover to another node.

At act 1030, the user equipment may determine whether the adjusted non-terrestrial network node handover criterion/adjusted handover event criterion is satisfied (e.g., the user equipment may determine whether a signal strength corresponding to a target non-terrestrial network node exceeds a signal strength corresponding to a terrestrial radio access network node currently serving the user equipment by an adjusted amount that is less than a previously configured handover criterion). If a determination is made at act 1030 that a signal strength corresponding to a target non-terrestrial radio node does not exceed a signal strength corresponding to the radio access network node currently serving the user equipment by an adjusted amount that is less than a previously configured handover criterion, method 1000 returns to act 1020 and the user equipment continues to measure signal strengths corresponding to reference signals broadcast or transmitted by the radio access network node that is currently serving the user equipment.

If a determination is made at act 1030 that a signal strength corresponding to a target non terrestrial radio node equals or exceeds a signal strength corresponding to radio access network node currently serving the user equipment by an adjusted amount that is less than a previously-configured/already-configured handover criterion, method 1000 advances to act 1035. At act 1035, the user equipment may transmit, to the terrestrial radio access network node that is currently serving the user equipment, a handover request. Responsive to the handover request transmitted by the user equipment at act 1035, the terrestrial radio access network node may transmit, at act 1040 to a non-terrestrial network element, a non-terrestrial network fast handover request, such as request 320 described in reference to FIG. 3. Responsive to the non-terrestrial network fast handover request transmitted at act 1040, at act 1045 a non-terrestrial network element may transmit to the terrestrial radio access network node a non-terrestrial network fast handover request response, such as response 325 described in reference to FIG. 3. The response transmitted at act 1045 may comprise time and frequency resource information indicative of downlink time and frequency resources usable by the user equipment to receive connection establishment setup information from a non-terrestrial network node to which the user equipment requested hand over at act 1035. The response transmitted at act 1045 may comprise downlink beam information, corresponding to the non-terrestrial network node to which the user equipment requested handover at act 1035, usable by the user equipment to receive connection establishment information according to time and frequency resources indicated in the response transmitted at act 1045.

At act 1050, the terrestrial radio access network node may transmit, to the user equipment, a non-terrestrial network fast handover command comprising fast handover configuration information usable by the user equipment to obtain connection establishment setup information from the non-terrestrial network node to which the user equipment requested handover via the handover request transmitted at act 1035. The non-terrestrial network fast handover command may comprise downlink resource information and beam information transmitted by the non-terrestrial network node to the terrestrial at act 1045. The non-terrestrial network fast handover command transmitted at act 1050 may comprise a timing advance value, corresponding to the user equipment, determined with respect to the non-terrestrial network node to which the user equipment requested handover at act 1035. At act 1055, the user equipment may use information transmitted by the terrestrial radio access network node at act 1050 in the non-terrestrial network fast handover command to receive connection establishment setup information. At act 1060, the user equipment may establish a connection with the non-terrestrial network node, to which the user equipment requested handover at act 1035, according to setup information received at act 1055, and may flush connection information corresponding to a connection the user equipment may have had with the terrestrial radio access network node. Method 1000 may advance to act 1065 and end.

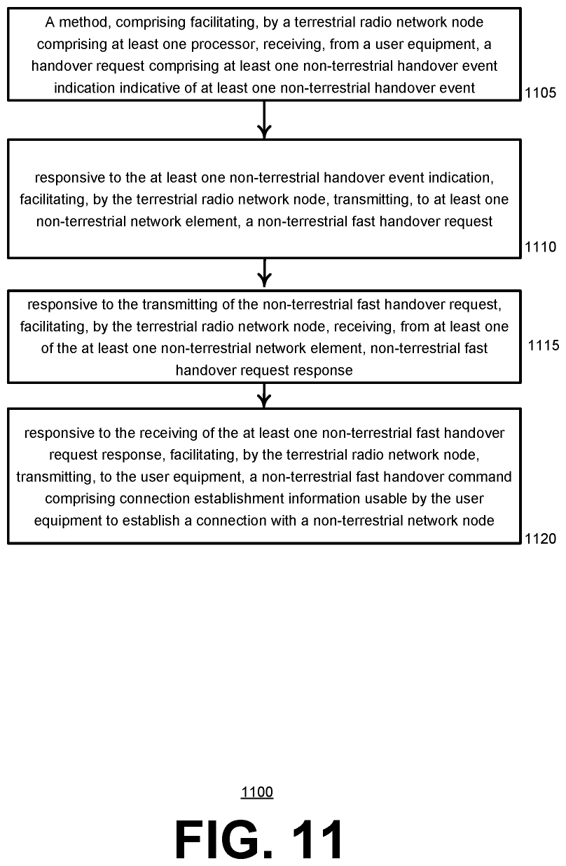

Turning now to FIG. 11, the figure illustrates an example embodiment method 1100 comprising at block 1105 facilitating, by a terrestrial radio network node comprising at least one processor, receiving, from a user equipment, a handover request comprising at least one non-terrestrial handover event indication indicative of at least one non-terrestrial handover event, at block 1110 responsive to the at least one non-terrestrial handover event indication, facilitating, by the terrestrial radio network node, transmitting, to at least one non-terrestrial network element, a non-terrestrial fast handover request; at block 1115 responsive to the transmitting of the non-terrestrial fast handover request, facilitating, by the terrestrial radio network node, receiving, from at least one of the at least one non-terrestrial network element, non-terrestrial fast handover request response, and at block 1120 responsive to the receiving of the at least one non-terrestrial fast handover request response, facilitating, by the terrestrial radio network node, transmitting, to the user equipment, a non-terrestrial fast handover command comprising connection establishment information usable by the user equipment to establish a connection with a non-terrestrial network node.

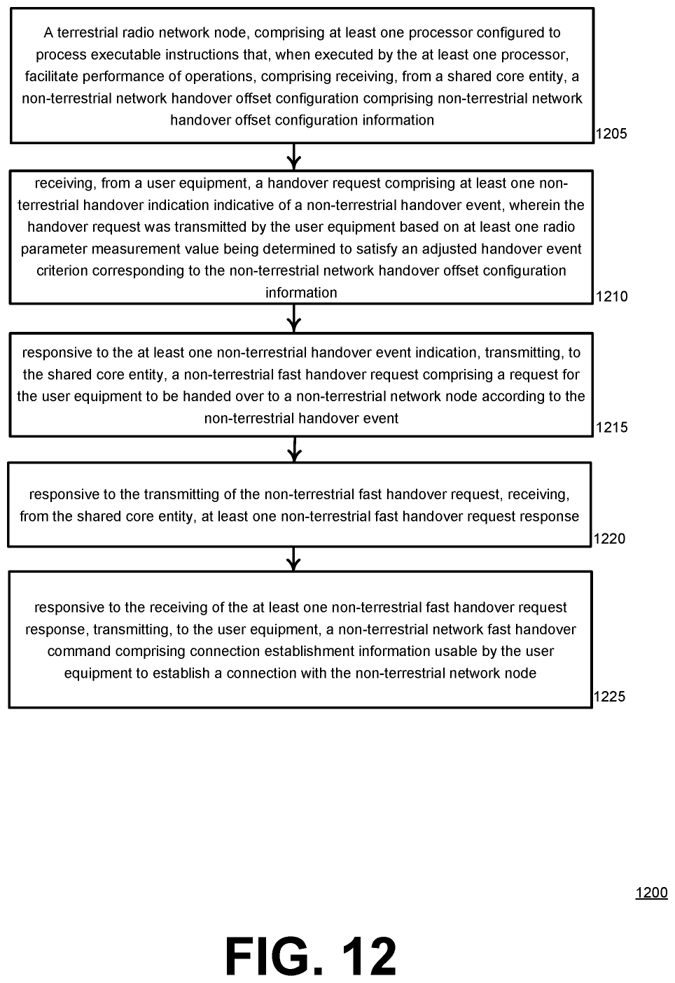

Turning now to FIG. 12, the figure illustrates a terrestrial radio network node 1200, comprising at block 1205 at least one processor configured to process executable instructions that, when executed by the at least one processor, facilitate performance of operations, comprising receiving, from a shared core entity, a non-terrestrial network handover offset configuration comprising non-terrestrial network handover offset configuration information; at block 1210 receiving, from a user equipment, a handover request comprising at least one non-terrestrial handover indication indicative of a non-terrestrial handover event, wherein the handover request was transmitted by the user equipment based on at least one radio parameter measurement value being determined to satisfy an adjusted handover event criterion corresponding to the non-terrestrial network handover offset configuration information, at block 1215 responsive to the at least one non-terrestrial handover event indication, transmitting, to the shared core entity, a non-terrestrial fast handover request comprising a request for the user equipment to be handed over to a non-terrestrial network node according to the non-terrestrial handover event; at block 1220 responsive to the transmitting of the non-terrestrial fast handover request, receiving, from the shared core entity, at least one non-terrestrial fast handover request response; at block 1225 responsive to the receiving of the at least one non-terrestrial fast handover request response, transmitting, to the user equipment, a non-terrestrial network fast handover command comprising connection establishment information usable by the user equipment to establish a connection with the non-terrestrial network node.

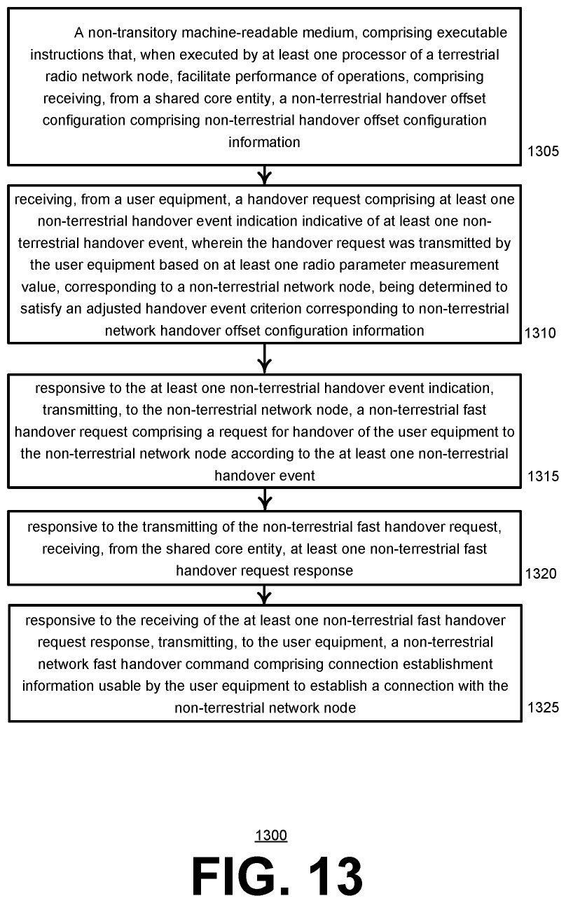

Turning now to FIG. 13 the figure illustrates a non-transitory machine-readable medium 1300 comprising at block 1305 executable instructions that, when executed by at least one processor of a terrestrial radio network node, facilitate performance of operations, comprising receiving, from a shared core entity, a non-terrestrial handover offset configuration comprising non-terrestrial handover offset configuration information; at block 1310 receiving, from a user equipment, a handover request comprising at least one non-terrestrial handover event indication indicative of at least one non-terrestrial handover event, wherein the handover request was transmitted by the user equipment based on at least one radio parameter measurement value, corresponding to a non-terrestrial network node, being determined to satisfy an adjusted handover event criterion corresponding to non-terrestrial network handover offset configuration information; at block 1315 responsive to the at least one non-terrestrial handover event indication, transmitting, to the non-terrestrial network node, a non-terrestrial fast handover request comprising a request for handover of the user equipment to the non-terrestrial network node according to the at least one non-terrestrial handover event; at block 1320 responsive to the transmitting of the non-terrestrial fast handover request, receiving, from the shared core entity, at least one non-terrestrial fast handover request response; and at block 1325 responsive to the receiving of the at least one non-terrestrial fast handover request response, transmitting, to the user equipment, a non-terrestrial network fast handover command comprising connection establishment information usable by the user equipment to establish a connection with the non-terrestrial network node.

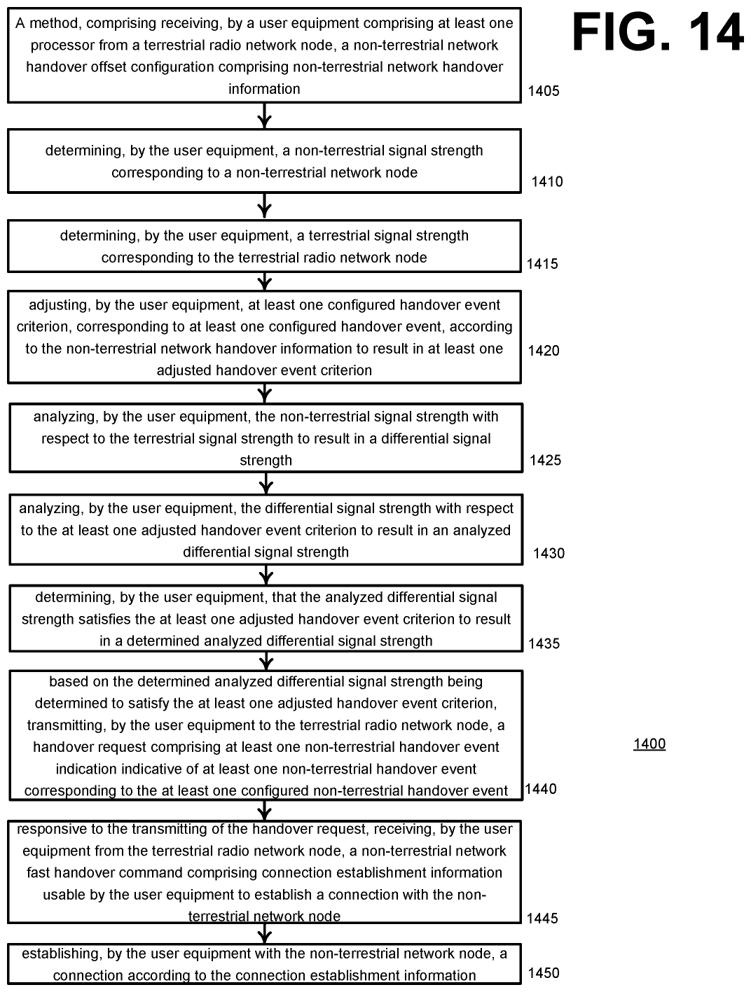

Turning now to FIG. 14, the figure illustrates an example embodiment method 1400 comprising, at block 1405, receiving, by a user equipment comprising at least one processor from a terrestrial radio network node, a non-terrestrial network handover offset configuration comprising non-terrestrial network handover information; at block 1410 determining, by the user equipment, a non-terrestrial signal strength corresponding to a non-terrestrial network node; at block 1415 determining, by the user equipment, a terrestrial signal strength corresponding to the terrestrial radio network node; at block 1420 adjusting, by the user equipment, at least one configured handover event criterion, corresponding to at least one configured handover event, according to the non-terrestrial network handover information to result in at least one adjusted handover event criterion; at block 1425 analyzing, by the user equipment, the non-terrestrial signal strength with respect to the terrestrial signal strength to result in a differential signal strength; at block 1430 analyzing, by the user equipment, the differential signal strength with respect to the at least one adjusted handover event criterion to result in an analyzed differential signal strength; at block 1435 determining, by the user equipment, that the analyzed differential signal strength satisfies the at least one adjusted handover event criterion to result in a determined analyzed differential signal strength; at block 1440 based on the determined analyzed differential signal strength being determined to satisfy the at least one adjusted handover event criterion, transmitting, by the user equipment to the terrestrial radio network node, a handover request comprising at least one non-terrestrial handover event indication indicative of at least one non-terrestrial handover event corresponding to the at least one configured non-terrestrial handover event; at block 1445 responsive to the transmitting of the handover request, receiving, by the user equipment from the terrestrial radio network node, a non-terrestrial network fast handover command comprising connection establishment information usable by the user equipment to establish a connection with the non-terrestrial network node; and at block 1450 establishing, by the user equipment with the non-terrestrial network node, a connection according to the connection establishment information.

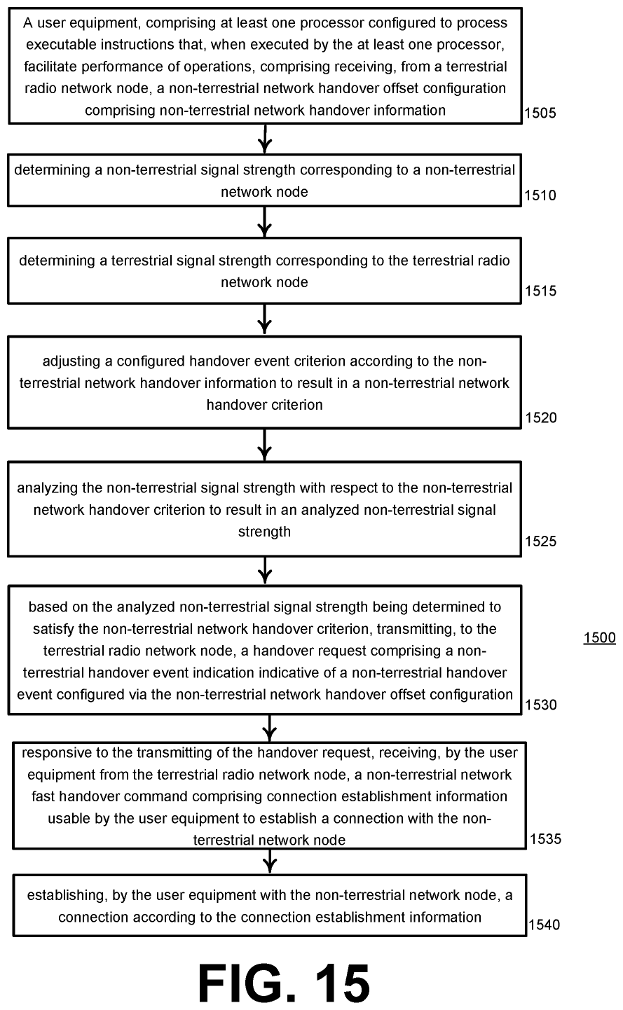

Turning now to FIG. 15, the figure illustrates an example user equipment 1500, comprising at block 1505 at least one processor configured to process executable instructions that, when executed by the at least one processor, facilitate performance of operations, comprising receiving, from a terrestrial radio network node, a non-terrestrial network handover offset configuration comprising non-terrestrial network handover information; at block 1510 determining a non-terrestrial signal strength corresponding to a non-terrestrial network node; at block 1515 determining a terrestrial signal strength corresponding to the terrestrial radio network node; at block 1520 adjusting a configured handover event criterion according to the non-terrestrial network handover information to result in a non-terrestrial network handover criterion; at block 1525 analyzing the non-terrestrial signal strength with respect to the non-terrestrial network handover criterion to result in an analyzed non-terrestrial signal strength; at block 1530 based on the analyzed non-terrestrial signal strength being determined to satisfy the non-terrestrial network handover criterion, transmitting, to the terrestrial radio network node, a handover request comprising a non-terrestrial handover event indication indicative of a non-terrestrial handover event configured via the non-terrestrial network handover offset configuration; at block 1535 responsive to the transmitting of the handover request, receiving, by the user equipment from the terrestrial radio network node, a non-terrestrial network fast handover command comprising connection establishment information usable by the user equipment to establish a connection with the non-terrestrial network node; and at block establishing, by the user equipment with the non-terrestrial network node, a connection according to the connection establishment information.

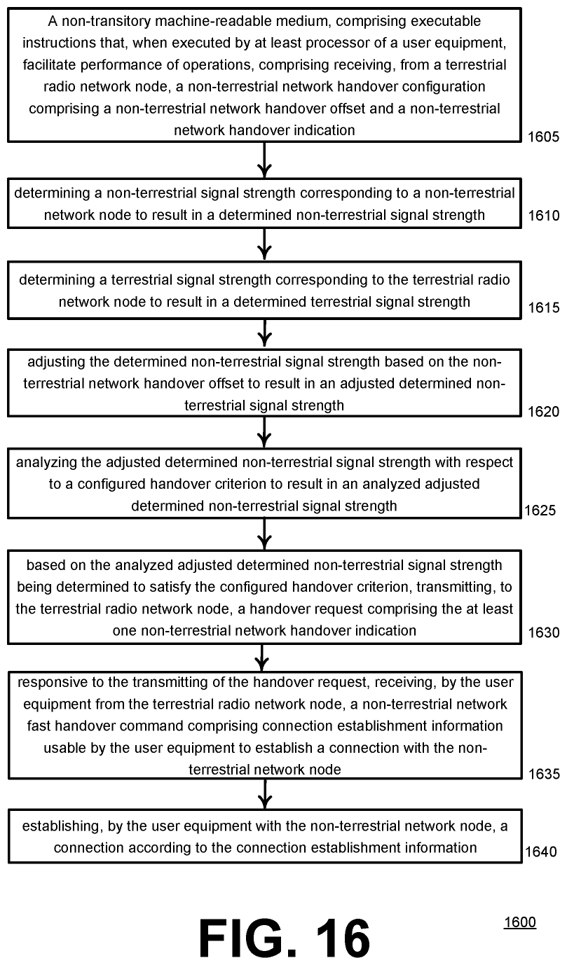

Turning now to FIG. 16, the figure illustrates a non-transitory machine-readable medium 1600 comprising at block 1605 executable instructions that, when executed by at least one processor of a user equipment, facilitate performance of operations, comprising receiving, from a terrestrial radio network node, a non-terrestrial network handover configuration comprising a non-terrestrial network handover offset and a non-terrestrial network handover indication; at block 1610 determining a non-terrestrial signal strength corresponding to a non-terrestrial network node to result in a determined non-terrestrial signal strength; at block 1615 determining a terrestrial signal strength corresponding to the terrestrial radio network node to result in a determined terrestrial signal strength; at block 1620 adjusting the determined non-terrestrial signal strength based on the non-terrestrial network handover offset to result in an adjusted determined non-terrestrial signal strength; at block 1625 analyzing the adjusted determined non-terrestrial signal strength with respect to a configured handover criterion to result in an analyzed adjusted determined non-terrestrial signal strength; at block 1630 based on the analyzed adjusted determined non-terrestrial signal strength being determined to satisfy the configured handover criterion, transmitting, to the terrestrial radio network node, a handover request comprising the at least one non-terrestrial network handover indication; at block 1635 responsive to the transmitting of the handover request, receiving, by the user equipment from the terrestrial radio network node, a non-terrestrial network fast handover command comprising connection establishment information usable by the user equipment to establish a connection with the non-terrestrial network node; and at block 1640 establishing, by the user equipment with the non-terrestrial network node, a connection according to the connection establishment information.

In order to provide additional context for various embodiments described herein, FIG. 17 and the following discussion are intended to provide a brief, general description of a suitable computing environment 1700 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors and may include a cache memory. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

Computer 1702 further includes an internal hard disk drive (HDD) 1714 (e.g., EIDE, SATA), one or more external storage devices 1716 (e.g., a magnetic floppy disk drive (FDD) 1716, a memory stick or flash drive reader, a memory card reader, etc.) and an optical disk drive 1720 (e.g., which can read or write from a CD-ROM disc, a DVD, a BD, etc.). While the internal HDD 1714 is illustrated as located within the computer 1702, the internal HDD 1714 can also be configured for external use in a suitable chassis (not shown). Additionally, while not shown in environment 1700, a solid-state drive (SSD) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can comprise a security module, such as a trusted processing module (TPM). For instance, with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are example and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

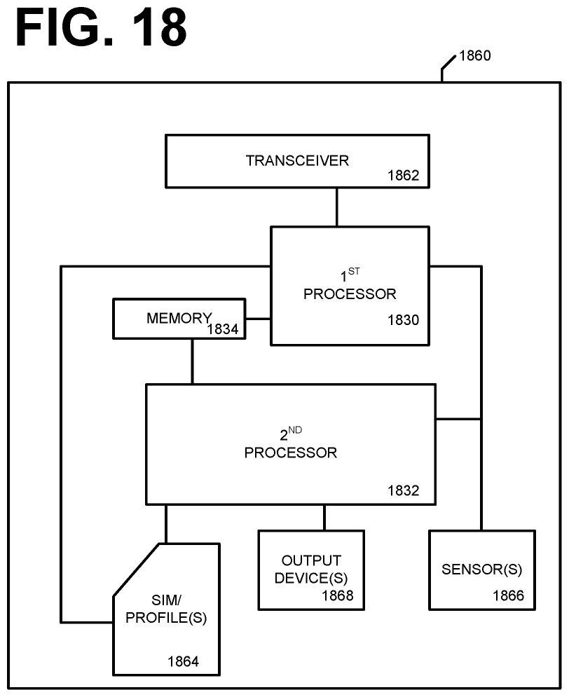

Turning to FIG. 18, the figure illustrates a block diagram of an example UE 1860. UE 1860 may comprise a smart phone, a wireless tablet, a laptop computer with wireless capability, a wearable device, a machine device that may facilitate vehicle telematics, a tracking device, remote sensing devices, and the like. UE 1860 comprises a first processor 1830, a second processor 1832, and a shared memory 1834. UE 1860 includes radio front end circuitry 1862, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 1862 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 18, UE 1860 may also include a SIM 1864, or a SIM profile, which may comprise information stored in a memory (memory 1834 or a separate memory portion), for facilitating wireless communication with RAN 105 or core network 130 shown in FIG. 1. FIG. 18 shows SIM 1864 as a single component in the shape of a conventional SIM card, but it will be appreciated that SIM 1864 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1864 and another device, which may be a component of RAN 105 or core network 130 shown in FIG. 1). A SIM profile 1864 may also comprise identifying information that is unique to the SIM, or SIM profile, such as, for example, an International Mobile Subscriber Identity (“IMSI”) or information that may make up an IMSI.

SIM 1864 is shown coupled to both the first processor portion 1830 and the second processor portion 1832. Such an implementation may provide an advantage that first processor portion 1830 may not need to request or receive information or data from SIM 1864 that second processor 1832 may request, thus eliminating the use of the first processor acting as a ‘go-between’ when the second processor uses information from the SIM in performing its functions and in executing applications. First processor 1830, which may be a modem processor or a baseband processor, is shown smaller than processor 1832, which may be a more sophisticated application processor, to visually indicate the relative levels of sophistication (i.e., processing capability and performance) and corresponding relative levels of operating power consumption levels between the two processor portions. Keeping the second processor portion 1832 asleep/inactive/in a low power state when UE 1860 does not need it for executing applications and processing data related to an application provides an advantage of reducing power consumption when the UE only needs to use the first processor portion 1830 while in listening mode for monitoring routine configured bearer management and mobility management/maintenance procedures, or for monitoring search spaces that the UE has been configured to monitor while the second processor portion remains inactive/asleep.

UE 1860 may also include sensors 1866, such as, for example, temperature sensors, accelerometers, gyroscopes, barometers, moisture sensors, and the like that may provide signals to the first processor 1830 or second processor 1832. Output devices 1868 may comprise, for example, one or more visual displays (e.g., computer monitors, VR appliances, and the like), acoustic transducers, such as speakers or microphones, vibration components, and the like. Output devices 1868 may comprise software that interfaces with output devices, for example, visual displays, speakers, microphones, touch sensation devices, smell or taste devices, and the like, that are external to UE 1860.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| AI | Artificial intelligence |
| ML | Machine learning |
| QCI | QoS Class Identifiers |
| BSR | Buffer status report |
| SBFD | Sub-band full duplex |
| CLI | Cross link interference |
| TDD | Time division duplexing |
| FDD | Frequency division duplexing |
| AI | Artificial intelligence |
| ML | Machine learning |
| MCS | Modulation and coding scheme |
| IE | Information element |
| BS | Base station |
| RRC | Radio resource control |
| UCI | Uplink control information |
| UE | User equipment |
| WTRU | Wireless transmit receive unit |
| CBR | Channel busy ratio |
| SCI | Sidelink control information |
| QoS | Quality of service |
| PER | Packet error rate |
| PDB | Packet delay budget |
| E2E | End to end |
| NES | Network energy saving |
| QCI | Quality class indication |
| RSRP | Reference signal received power |
| PCI | Primary cell ID |
| CSI-RS | Channel state information reference signals |
| PTRS | Phase tracking reference signals |
| DTX | Discontinuous transmission or discontinuous transmit |
| DRX | Discontinuous reception or discontinuous receive |
| CG | Configured grant |
| ULP | Uplink power |
| FBS | Fake base station |
| NTN | Non terrestrial network |
| gRAN | Ground radio access network |
| RAN | Radio access network |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a terrestrial radio network node comprising at least one processor, receiving, from a user equipment, a handover request comprising at least one non-terrestrial handover event indication indicative of at least one non-terrestrial handover event;
responsive to the at least one non-terrestrial handover event indication, facilitating, by the terrestrial radio network node, transmitting, to at least one non-terrestrial network element, a non-terrestrial fast handover request;
responsive to the transmitting of the non-terrestrial fast handover request, facilitating, by the terrestrial radio network node, receiving, from at least one of the at least one non-terrestrial network element, non-terrestrial fast handover request response; and
responsive to the receiving of the at least one non-terrestrial fast handover request response, facilitating, by the terrestrial radio network node, transmitting, to the user equipment, a non-terrestrial fast handover command comprising connection establishment information usable by the user equipment to establish a connection with a non-terrestrial network node.

2. The method of claim 1, wherein the non-terrestrial fast handover request comprises at least one of: a non-terrestrial network downlink control resource request for at least one non-terrestrial network downlink control resource usable by the user equipment to facilitate receiving connection setup information, a non-terrestrial downlink beam information request for non-terrestrial downlink beam information usable by the user equipment to facilitate the receiving of the connection setup information, or radio resource control setup request information, associated with the user equipment, usable by the non-terrestrial network node to facilitate establishment of a connection between the non-terrestrial network node and the user equipment.

3. The method of claim 1, wherein the at least one non-terrestrial fast handover request response comprises at least one of: at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate the receiving of the connection setup information.

4. The method of claim 1, wherein the connection establishment information comprises at least one of: a non-terrestrial network node identifier corresponding to the non-terrestrial network node, a timing advance value corresponding to the non-terrestrial network node, at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate the receiving of the connection setup information.

5. The method of claim 1, further comprising facilitating, by the terrestrial radio network node, receiving, from at least one of the at least one non-terrestrial network element a first non-terrestrial network handover offset configuration comprising at least one of: at least one non-terrestrial signal strength offset corresponding to at least one non-terrestrial network node, or at least one handover event indication indicative of at least one handover event, with respect to which the at least one non-terrestrial signal strength offset is to be applicable.

6. The method of claim 5, wherein the handover request comprising the at least one non-terrestrial handover event indication is based on a non-terrestrial signal strength corresponding to the non-terrestrial network node being determined to be equal to or greater than at least one adjusted handover event criterion, wherein a configured at least one signal strength offset is adjusted by the at least one non-terrestrial signal strength offset to result in at least one adjusted handover offset, and wherein the at least one adjusted handover event criterion is a result of applying the at least one adjusted handover offset to a terrestrial signal strength corresponding to the terrestrial radio network node.

7. The method of claim 6, further comprising:
facilitating, by the terrestrial radio network node, transmitting, to the user equipment, a second non-terrestrial network handover offset configuration comprising at least one of: the at least one non-terrestrial signal strength offset, or the at least one handover event indication indicative of the at least one handover event, with respect to which the at least one non-terrestrial signal strength offset is to be applicable.

8. The method of claim 1, wherein the at least one non-terrestrial network element is at least one of: a shared core entity, a non-terrestrial gateway, or the non-terrestrial network node.

9. The method of claim 1, wherein the non-terrestrial fast handover request is delivered via at least one backhaul interface link, wherein the non-terrestrial fast handover request response is delivered via at least one backhaul interface link, or wherein the non-terrestrial fast handover command is delivered via at least one backhaul interface link.

10. The method of claim 9, wherein at least one of the at least one backhaul interface link is a microwave link.

11. A terrestrial radio network node, comprising at least one processor configured to process executable instructions that, when executed by the at least one processor, facilitate performance of operations, comprising:
receiving, from a shared core entity, a non-terrestrial network handover offset configuration comprising non-terrestrial network handover offset configuration information;
receiving, from a user equipment, a handover request comprising at least one non-terrestrial handover indication indicative of a non-terrestrial handover event, wherein the handover request was transmitted by the user equipment based on at least one radio parameter measurement value being determined to satisfy an adjusted handover event criterion corresponding to the non-terrestrial network handover offset configuration information;
responsive to the at least one non-terrestrial handover event indication, transmitting, to the shared core entity, a non-terrestrial fast handover request comprising a request for the user equipment to be handed over to a non-terrestrial network node according to the non-terrestrial handover event;
responsive to the transmitting of the non-terrestrial fast handover request, receiving, from the shared core entity, at least one non-terrestrial fast handover request response; and
responsive to the receiving of the at least one non-terrestrial fast handover request response, transmitting, to the user equipment, a non-terrestrial network fast handover command comprising connection establishment information usable by the user equipment to establish a connection with the non-terrestrial network node.

12. The terrestrial radio network node of claim 11, wherein the non-terrestrial network handover offset configuration information comprises at least one of: at least one non-terrestrial signal strength offset corresponding to at least one non-terrestrial network node, or at least one handover event indication indicative of at least one handover event with respect to which the at least one non-terrestrial signal strength offset is to be applicable.

13. The terrestrial network node of claim 11, wherein the shared core entity is configured to facilitate exchanging of information between the non-terrestrial network node and the terrestrial radio network node.

14. The terrestrial network node of claim 11, wherein the connection establishment information comprises at least one of: a non-terrestrial network node identifier corresponding to the non-terrestrial network node, a timing advance value corresponding to the non-terrestrial network node, at least one non-terrestrial network downlink control resource indication indicative of at least one non-terrestrial network downlink control resource usable by the user equipment to facilitate receiving connection setup information from the non-terrestrial network node, or at least one non-terrestrial downlink beam indication indicative of at least one downlink beam usable by the user equipment to facilitate receiving the connection setup information.

15. The terrestrial network node of claim 14, wherein the at least one non-terrestrial network downlink control resource usable by the user equipment to facilitate receiving connection setup information comprises radio resource control connection establishment setup information.

16. A non-transitory machine-readable medium, comprising executable instructions that, when executed by at least one processor of a terrestrial radio network node, facilitate performance of operations, comprising:
receiving, from a shared core entity, a non-terrestrial handover offset configuration comprising non-terrestrial handover offset configuration information;
receiving, from a user equipment, a handover request comprising at least one non-terrestrial handover event indication indicative of at least one non-terrestrial handover event, wherein the handover request was transmitted by the user equipment based on at least one radio parameter measurement value, corresponding to a non-terrestrial network node, being determined to satisfy an adjusted handover event criterion corresponding to non-terrestrial network handover offset configuration information;
responsive to the at least one non-terrestrial handover event indication, transmitting, to the non-terrestrial network node, a non-terrestrial fast handover request comprising a request for handover of the user equipment to the non-terrestrial network node according to the at least one non-terrestrial handover event;
responsive to the transmitting of the non-terrestrial fast handover request, receiving, from the shared core entity, at least one non-terrestrial fast handover request response; and
responsive to the receiving of the at least one non-terrestrial fast handover request response, transmitting, to the user equipment, a non-terrestrial network fast handover command comprising connection establishment information usable by the user equipment to establish a connection with the non-terrestrial network node.

17. The non-transitory machine-readable medium of claim 16, wherein the non-terrestrial network node comprises a satellite.

18. The non-transitory machine-readable medium of claim 17, wherein the non-terrestrial network node comprises a non-terrestrial network node gateway configured to facilitate communication of signals between the satellite and the terrestrial radio network node via at least one microwave interface.

19. The non-transitory machine-readable medium of claim 18, wherein the receiving of the non-terrestrial network handover offset configuration comprises receiving the non-terrestrial network handover offset configuration from the non-terrestrial network node gateway, and wherein the transmitting of the non-terrestrial fast handover request comprises transmitting the non-terrestrial fast handover request to the non-terrestrial network node gateway.

20. The non-transitory machine-readable medium of claim 16, wherein the non-terrestrial handover offset configuration information comprises at least one non-terrestrial signal strength offset and at least one non-terrestrial handover event indication indicative of the at least one non-terrestrial handover event, with respect to which the at least one non-terrestrial signal strength offset is to be applicable.
